(19) United States
(12) Patent Application Publication
(10) Pub. No.: US 2026/0359573 A1
(43) Pub. Date: Nov. 12, 2026

(54) Conversational Artificial Intelligence Systems Using Simulated Conversations And Sentiment Analysis

(71) Applicant: Oracle International Corporation, Redwood Shores, CA (US)

(72) Inventors: Amit Agarwal, Seattle, WA (US); Priyaranjan Pattnayak, Snohomish, WA (US); Hansa Meghwani, Bengaluru (IN)

(73) Assignee: Oracle International Corporation, Redwood Shores, CA (US)

(21) Appl. No.: 19/091,777

(22) Filed: Mar. 26, 2025

(51) Int. Cl. G06F 40/35; G06F 16/93; G06N 3/042; G06N 3/0455

(52) U.S. Cl. CPC G06F 40/35; G06F 16/93; G06N 3/042; G06N 3/0455

(57) ABSTRACT

Computer-implemented techniques improve conversational AI system performance by analyzing conversations to identify segments including negative changes in user experience. The techniques identify source documents used to generate answers within problematic segments and locate similar but unused documents from available knowledge sources. Simulated conversations test alternative documents by recreating problematic query-answer exchanges. When simulations demonstrate improved user experience metrics using alternative documents, the techniques update AI system models and knowledge bases to incorporate superior content. The automated approach enables continuous refinement of conversational AI performance through systematic identification of problematic exchanges, controlled testing of knowledge alternatives, and targeted updates to system resources. The techniques provide particular advantages in technical support applications where documentation frequently changes, helping maintain consistent support quality as products evolve through automated detection and correction of documentation-related issues.

### TECHNICAL FIELD

This disclosure relates generally to artificial intelligence. More particularly, this disclosure relates to conversational artificial intelligence systems.

### BACKGROUND

End users interacting with generative artificial intelligence (AI) chatbots seeking support experience frustration due to inaccurate responses and fragmented documentation. The existence of siloed and duplicate content compounds these issues, resulting in inconsistent answers. Users signal dissatisfaction through specific behaviors—conversation abandonment, support escalations, and unresolved queries. Sentiment variations during multi-turn conversations provide valuable performance indicators though current systems lack mechanisms to capture and analyze these signals.

The absence of automated systems for converting implicit user feedback and behavioral data into training datasets prevents machine learning model improvements based on real-world interactions. Manual analysis of large-scale interaction data and documentation presents significant operational challenges. The lack of an automated framework for processing feedback (both explicit and implicit), prioritizing customer issues, and extracting usage patterns creates bottlenecks in model improvement cycles. These limitations impact the ability to deliver efficient customer support and maintain competitive advantages in services marketplaces, such as cloud services, where generative AI chatbots are used to support end-users.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

One or more embodiments of the present disclosure are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates an example system and method for analyzing conversations between users and an AI system, identifying negative experiences, and improving responses using alternative documents according to one or more embodiments;

FIG. 2 illustrates a system and method for analyzing conversations through sentiment scoring, reward scoring, reward deviation scoring, and sentiment labeling to determine sentiment-reward deviation indexes according to one or more embodiments;

FIG. 3 illustrates a system and method for detecting conversation transition points using behavioral indicators and sentiment-reward deviation indices to identify segments with negative user experience according to one or more embodiments;

FIG. 4 illustrates a system and method for detecting conversation transition points using behavioral indicators, including support escalation, ticket creation, conversation abandonment, and user rudeness according to one or more embodiments;

FIG. 5 illustrates a system and method for detecting conversation transition points using sentiment scores, reward scores, and deviation indexes to identify segments indicating user dissatisfaction according to one or more embodiments;

FIG. 6 illustrates a system and method for identifying similar documents using parallel processing of vector representations, key-phrases, and topics extracted from a first document according to one or more embodiments;

FIG. 7 illustrates a system and method for simulating a second conversation using conversation context from a first conversation and a second document to generate an AI response according to one or more embodiments;

FIG. 8 illustrates a system and method for determining conversation segment sentiment through analysis of sentiment scores, reward scores, and deviation indexes to evaluate user experience according to one or more embodiments;

FIG. 9 illustrates a system and method for fine-tuning document reranking and embedding models based on successful conversation outcomes using a second document according to one or more embodiments;

FIG. 10 illustrates a system and method for updating knowledge bases based on successful simulated conversations that demonstrate improved user experience without negative interactions according to one or more embodiments;

FIG. 11 illustrates an example transformer model architecture that may be used in the implementation of a language model according to one or embodiments of the present disclosure; and

FIG. 12 is a block diagram that illustrates an example computer system upon which one or more embodiments are implemented.

### DETAILED DESCRIPTION

In the following detailed description, for the purposes of explanation, numerous specific details are set forth to aid understanding of one or more embodiments of the present disclosure. In some instances, one or embodiments of the present disclosure may be practiced without one or more of these specific details. In some cases, a described feature of one embodiment of the present disclosure is also a feature of one or more other embodiments of the present disclosure even though the feature is not expressly described with respect to one or more other embodiments. In one or more embodiments, well-known structures and devices are shown in the figures in block diagram form to avoid unnecessarily obscuring the embodiment.
1. GENERAL OVERVIEW
2. IMPROVING ARTIFICIAL INTELLIGENCE SYSTEMS USING SIMULATED CONVERSATIONS AND SENTIMENT ANALYSIS
3. EXAMPLE EMBODIMENT
4. PRACTICAL APPLICATIONS; ADVANTAGES; IMPROVEMENTS
5. EXAMPLE LANGUAGE MODEL ARCHITECTURE
6. COMPUTER NETWORKS AND CLOUD NETWORKS
7. HARDWARE OVERVIEW
8. MISCELLANEOUS; EXTENSIONS

### 1. General Overview

One or more embodiments improve conversational AI performance through automated analysis and document optimization. The system analyzes conversations between users and a conversational AI system to identify specific segments where user experience deteriorates. These segments are isolated as sets of query-answer pairs from the conversation. The system then identifies source documents used by the conversational AI to generate answers within the problematic segments. Upon identifying a source document linked to a negative user experience, the system locates similar but previously unused documents from the available corpus. The system then conducts simulated conversations using these alternative documents, specifically recreating the problematic query-answer exchanges with new source material. The simulated conversations serve as a testing ground to evaluate if the alternative documents produce better outcomes. When it is determined that a simulated conversation segment using an alternative document avoids the negative user experience present in the original conversation, the system proceeds to update the AI system's models and knowledge bases. The updating step incorporates the superior alternative documents into the AI system's knowledge framework. This modification aims to prevent similar negative user experiences in future conversations by providing the AI with better source material for generating responses.

One or more embodiments represent an automated approach to conversational AI optimization that identifies problematic exchanges, tests alternative knowledge sources, and updates system resources when improvements are confirmed through simulation. The systematic nature of the process enables continuous refinement of the AI system's performance based on actual user interactions and documented outcomes.

One or more embodiments described in this Specification and/or recited in the claims may not be included in the General Overview section.

### 2.0 Improving Artificial Intelligence Systems Using Simulated Conversations and Sentiment Analysis

One or more embodiments will now be described with respect to the figures. In one or more embodiments, a system depicted in a figure may include more or fewer components than the components illustrated in the figure. The components illustrated in the figure may be local to or remote from each other. The components illustrated in the figure may be implemented in software and/or hardware. Each component may be distributed over multiple applications and/or machines. Multiple components may be combined into one application and/or machine. Operations described with respect to one component may instead be performed by another component. Additional embodiments and/or examples relating to computer networks are described below in Section 6, titled “Computer Networks and Cloud Networks.” In one or more embodiments, one or more operations of a method illustrated in a figure may be modified, rearranged, or omitted. Accordingly, the particular sequence of operations illustrated in a figure should not be construed as limiting the scope of one or more embodiments.

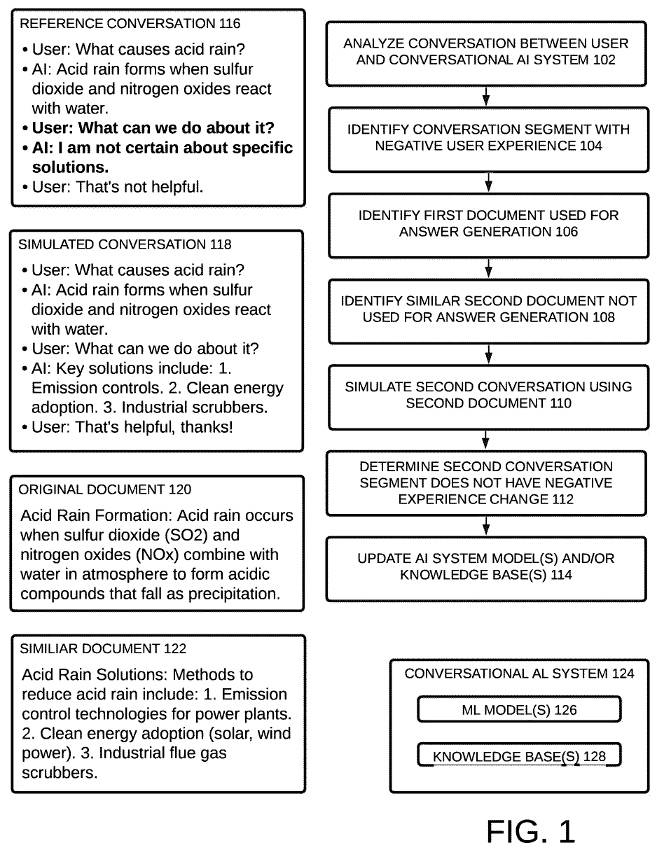

FIG. 1 illustrates an example system and method 100 for analyzing conversations between users and an AI system, identifying negative experiences, and improving responses using alternative documents according to one or more embodiments.

The system and method 100 encompass an approach for improving conversational AI systems through analysis and simulation of conversations. The system and method 100 analyze an initial conversation 116 between a user and a conversational AI system 124 (Operation 102). During this analysis, the system and method 100 identifies specific segments of the conversation where there is a detectable negative change in user experience (Operation 104). These segments include query-answer pairs that represent the back-and-forth exchange between the user and the AI system.

The system and method 100 then trace back to identify an original document 120 that the conversational AI system 124 used to generate a particular answer within the problematic conversation segment (Operation 106). Using this document as a reference point, the system and method 100 identifies a similar but distinct document 122 that was not utilized in generating the original answer (Operation 108). Document similarity comparison enables exploration of alternative response paths.

The system and method 100 then conduct a simulation of a new conversation 118 using the identified similar document (Operation 110). In this simulation, the conversational AI system 124 generates new answers to the same user queries that were present in the original problematic segment. The simulation allows for evaluation of how the conversation might have proceeded differently with alternative source material.

The system and method 100 include an evaluation phase where the system determines if the simulated conversation segment exhibits the same negative user experience patterns as the original conversation (Operation 112). If the simulated conversation demonstrates improved user experience (e.g., does not show negative changes), the system and method 100 proceed to update the underlying model(s) 126 and/or knowledge base(s) 128 (Operation 114). This update incorporates the alternative document that led to better conversational outcomes.

Through this iterative process of analysis, simulation, and improvement, the system and method 100 provide an approach to enhancing the conversational AI system 124's performance. The system and method 100 learn from problematic interactions and adapt underlying model(s) 126 and/or knowledge base(s) 128 to potentially prevent similar issues in future conversations. This self-improving mechanism helps maintain and enhance the quality of AI-driven conversations over time.

The system and method 100 analyze (Operation 102) reference conversations between users and AI through five technical components:
1. Sentiment analysis implements both discrete labels (Positive 1, Neutral 0, Negative −1) and continuous decimal scores (−1.0 to 1.0) through transformer-based neural networks. The networks process linguistic features and contextual cues via multiple attention layers, mapping continuous scores to discrete sentiment labels through empirically determined thresholds (above 0.3 for Positive, between −0.3 and 0.3 for Neutral, below −0.3 for Negative).
2. Message Pair Evaluation calculates sentiment and reward scores through machine learning models with attention mechanisms. Multiple transformer encoder layers process sequential dependencies between user-chatbot messages. The model generates continuous decimal reward scores from −1.0 to 1.0 based on interaction quality, response relevance, and task completion. Feature extraction components analyze response latency, semantic similarity, clarifying questions, and conversation repair attempts.
3. Conversation context analysis employs a Conversation Confidence Score (CCS) calculator with dual-input neural architecture. The architecture processes message-level sentiment scores and response helpfulness metrics through parallel paths. Temporal decay weights follow exponential curves with recent messages receiving higher weights. The weighted combination produces a continuous CCS between 0.0 and 1.0, updating dynamically through sliding window mechanisms.
4. User behavior tracking monitors implicit and explicit feedback signals through machine learning systems. The systems record conversation termination events, escalation requests, and unresolved queries. Binary feedback collection enables users to mark responses as helpful or unhelpful. Statistical models quantify predictive power of conversation features for anticipating user dissatisfaction.
5. Topic and Intent Extraction utilizes transformer-based neural networks with multi-head attention mechanisms. The networks process text sequences through hierarchical encoding layers, maintaining topic taxonomies and tracking dynamic subject threads. Intent classification generates probability distributions across predefined categories, while context embedding combines extracted topics with conversation history features.

This analysis framework enables identification of problematic conversation segments and initiates improvement mechanisms through document comparison and conversation simulation.

The system and method 100 identify (Operation 104) negative user experience changes in conversations through automated detection and analysis of deteriorating segments. A sentiment and reward-deviation index (SADI) combines reward deviation scores with sentiment trends, while weighted average scoring emphasizes recent messages to track conversation tone evolution.

The analysis processes user-chatbot message pairs to generate sentiment labels (−1, 0, 1) and continuous decimal reward scores (−1.0 to 1.0). Reward deviation calculations measure absolute differences between consecutive reward scores in conversation sequences. The computation subtracts previous reward scores from current scores to quantify quality changes between adjacent conversation turns.

The SADI mechanism multiplies sentiment polarity with reward deviation magnitude. Negative sentiment (−1) multiplication produces negative SADI values indicating deterioration, while positive sentiment (1) multiplication yields positive values showing improvement. Neutral sentiment (0) multiplication results in zero SADI values regardless of deviation magnitude. Large negative SADI values highlight substantial reward deviations coinciding with negative sentiment, revealing potential conversation failures.

A weighted moving average applied to sequential SADI values implements exponential decay weighting for recent messages. The weighted average creates smoothed signals for conversation health monitoring while maintaining sensitivity to acute deterioration events. The identification process incorporates direct feedback signals, such as explicit negative user ratings and escalation requests, alongside indirect behavioral indicators, including conversation abandonment and expressed frustration.

In one or more embodiments, for a conversation consisting of sequential query-answer pairs, the system calculates a SADI score (ranging from −1 to 1) for each target query-answer pair. This score is determined by multiplying two components: the reward-deviation score (ranging from 0 to 1) and the sentiment label (either −1, 0, or 1) for the target pair. The reward-deviation score represents the absolute difference between the reward score of the target pair and the reward score of the immediately preceding query-answer pair in the conversation. Reward scores themselves range from −1 to 1 and measure response quality.

In one or more embodiments, the system determines the sentiment label for each target pair based on its sentiment score (which ranges from −1 to 1). The sentiment label is assigned as follows: a value of −1 if the sentiment score falls below a lower threshold (typically −0.5); a value of 0 if the sentiment score lies between the lower threshold and a higher threshold (typically 0.5); and a value of 1 if the sentiment score exceeds the higher threshold. These discrete sentiment labels help categorize user reactions as negative, neutral, or positive.

In one or more embodiments, the system calculates the sentiment label for a target pair by taking the minimum value between two scores: the individual sentiment score of the target pair and its contextual sentiment score. The contextual sentiment score represents an aggregate measure (such as average, mean, or weighted average) of sentiment scores from both the target pair and all preceding query-answer pairs in the conversation. In one embodiment, the system employs a weighted average that assigns higher importance to recent query-answer pairs and less weight to earlier exchanges, providing a more temporally relevant measure of conversation sentiment.

The detection system monitors multiple negative experience indicators, such as user rudeness/abuse, extended waiting periods without resolution, escalations to human support, and ticket creation requests. In addition to the SADI scoring mechanism that combines sentiment labels and reward deviations, this multi-indicator approach provides complementary signals for detecting user dissatisfaction. A data processing pipeline analyzes these indicators alongside the minimum of two scores—the individual sentiment score and the contextual sentiment score—to pinpoint specific conversation segments exhibiting user experience deterioration. This classification framework enhances the system's ability to identify problematic interactions through both quantitative metrics and qualitative behavioral patterns.

The system and method 100 identify (Operation 106) source documents used in conversational AI responses during segments of deteriorating user experience. Document identification operates through a retrieval and analysis framework engineered to process chat interactions at massive scale, handling over 300,000 chat sessions and traversing knowledge bases exceeding 600,000 pages.

The identification mechanism executes through sequential analysis steps when negative experience changes manifest in conversation segments. The system traces response generation paths backwards to locate source documents informing AI responses. This tracing leverages embedded document tracking capabilities within the conversational AI system, maintaining active records linking generated responses to source documents throughout chat interactions.

The document tracking subsystem creates persistent mappings between knowledge base documents and AI-generated responses, enabling precise identification of problematic source materials. These mappings support systematic analysis of document performance across large conversation datasets, facilitating targeted improvements to response generation quality.

The system and method 100 execute document similarity detection to identify (Operation 108) semantically or topically related documents that were not utilized in chatbot response generation during negative user experience segments. Document identification implements multiple search methodologies, including document embedding, vector search, and topic-based search, within a feedback-driven analysis framework.

The technical implementation leverages key-phrase search functionality to locate documents that include semantically equivalent phrases. Document analysis incorporates proprietary clustering models for topic extraction, complemented by document embedding and vector search techniques. These capabilities enable systematic identification of content overlaps and alternative documentation sources.

In one or more embodiments, the system and method 100 process documentation exceeding 600,000 pages and 80 billion tokens through automated clustering mechanisms. Clustering algorithms identify similar or redundant content segments across the knowledge base, surfacing potential alternative documents for response generation. Detecting similar documents serves dual objectives, enabling synthetic conversation simulation for response testing and identifying superior documentation to enhance system response quality.

The search methodology combines multiple technical approaches in parallel to maximize similarity detection accuracy. Vector search operations identify proximate document embeddings in high-dimensional semantic space. Topic-based search methods leverage extracted semantic clusters to group thematically related content. Key-phrase matching algorithms detect documents that share significant semantic vocabulary overlap.

The system and method 100 execute synthetic conversation simulations (Operation 110) through the conversational AI framework using semantically similar documents identified from prior negative interactions. A simulation engine recreates original user queries while substituting alternative knowledge base documents for response generation. This controlled simulation environment enables systematic evaluation of document performance without requiring live user interactions.

The simulation process implements comparative analysis between conversation paths generated from different source documents. When a document triggers negative user experiences, the system and method 100 identify semantically similar documents through embedding and clustering techniques. These alternative documents undergo synthetic conversation testing through the simulation pipeline. The pipeline generates responses using identified documents and evaluates resulting conversation quality metrics.

The simulation framework supports systematic testing of multiple document alternatives in parallel. Document performance evaluation occurs in an isolated test environment before changes propagate to production systems. Synthetic conversations measure document effectiveness through sentiment analysis, reward scoring, and user experience metrics. This evaluation methodology enables data-driven selection of optimal documentation for specific query types based on simulated interaction outcomes.

The controlled testing environment provides quantitative comparison between original problematic documents and potential alternatives. Response generation occurs under identical input conditions while varying the source documentation. This isolation of document impact on conversation quality enables precise measurement of documentation effectiveness.

The system and method 100 analyze (Operation 112) simulated conversation segments that correspond to previously identified problematic interactions from real user conversations. Analysis mechanisms evaluate synthetic conversations through multiple metrics, including sentiment scores, reward scores, and deviation patterns. The evaluation process detects the presence or absence of negative experience indicators, such as sentiment deterioration, user frustration signals, and conversational quality markers.

The SADI provides primary validation of simulated conversation quality and SADI calculations monitor value stability and polarity throughout conversation segments, confirming improvement over original negative interactions. Stable or positive SADI measurements validate the effectiveness of alternative documentation in maintaining consistent user experience quality.

A sentiment analysis subsystem assigns both discrete labels (Positive 1, Neutral 0, Negative −1) and continuous decimal scores to conversation segments. The CCS mechanism evaluates overall interaction quality by combining sentiment metrics with response helpfulness measurements. The combined scoring approach ensures comprehensive quality assessment across multiple conversation dimensions.

The determination phase validates performance improvements achieved through alternative documentation selection. Confirmation of negative experience elimination provides quantitative justification for knowledge base updates. The validation process supports systematic improvement of conversational AI models through document optimization based on simulated interaction outcomes.

The multi-metric evaluation framework enables precise comparison between original and simulated conversation segments. Comprehensive analysis of sentiment patterns, reward distributions, and deviation profiles confirms the absence of problematic interaction characteristics. Validated improvements guide strategic updates to AI system models and knowledge bases.

Operation 114 executes model and knowledge base updates through validated alternative documentation. The update mechanism modifies conversational AI components based on documents demonstrating superior response generation capabilities in simulated interactions.

Update procedures activate the following sequential validation steps: identification of problematic conversation segments, discovery of alternative documentation sources, and verification of improved conversation outcomes through synthetic simulations. The mechanism updates document reranking models, vector embedding systems, and generative language models based on successful simulation metrics.

Document-driven model updates are implemented through multiple technical pathways. Continuous learning pipelines integrate validated alternative documents into language model training sequences. Document reranking models undergo fine-tuning procedures based on demonstrated performance improvements in simulated conversations. Vector embedding systems receive updates reflecting enhanced semantic relationships discovered through document comparison.

The update framework establishes feedback loops that connect user interactions, document retrieval mechanisms, language model adaptation, and content management systems. These interconnected loops prevent concept and data drift while enabling systematic improvements based on real-world interaction patterns. The framework targets model enhancement through customer behavior analysis, synthetic conversation generation, and pseudo-labeling procedures utilizing documents with proven performance advantages.

Update operations maintain system coherence through coordinated modification of multiple AI components. Document reranking updates improve content prioritization based on simulation outcomes. Language model fine-tuning incorporates successful response patterns from alternative documentation. Knowledge base updates preserve demonstrated improvements while maintaining system stability.

The reference conversation 116 exemplifies conversation analysis and improvement processes within AI-driven chat interactions. Reference conversations undergo systematic evaluation through sentiment analysis, reward scoring, and SADI metrics. These conversations form part of a large-scale processing pipeline handling, in one or more embodiments, 300,000 or more chat sessions per six-month period.

The analysis framework processes multiple query-answer pairs within reference conversations to detect user experience deterioration. Sentiment scoring tracks transitions from positive or neutral states to negative emotional indicators. Reward calculations measure sequential declines across consecutive message pairs. Behavioral monitoring identifies explicit escalation requests and premature session terminations.

The detection system integrates multiple indicator classes for comprehensive experience evaluation. Sentiment analysis quantifies emotional state changes through discrete and continuous scoring mechanisms. Reward metrics track response effectiveness degradation across conversation segments. User behavior patterns reveal implicit dissatisfaction through abandonment events and support escalations. Direct feedback collection captures explicit negative ratings of chatbot responses.

Reference conversations serve as validation datasets for AI system improvements. The analysis pipeline identifies problematic segments through multi-metric evaluation, enabling targeted enhancement of response generation capabilities. Processing outcomes guide systematic updates to underlying models and knowledge bases through validated alternative documentation sources.

Simulated conversation 118 provides a synthetic testing environment for evaluating chatbot performance improvements through alternative documentation sources. The simulation framework generates controlled conversation scenarios by substituting similar documents in place of problematic source materials identified from negative user interactions.

Testing procedures recreate conversation flows while varying document selection parameters. When Document A triggers negative experiences in live interactions, the simulation engine generates parallel conversations using semantically similar Document B. Response generation mechanisms process identical user queries through alternative knowledge sources within the same or different knowledge base configurations to measure outcome differences.

Synthetic conversations enable systematic validation of document retrieval and response generation enhancements without live user dependencies. The simulation pipeline processes conversation segments extracted from negative user experiences to create controlled experimental conditions. Document substitution tests measure response quality changes through sentiment analysis and reward scoring metrics, allowing the system to identify both improvements and potential degradations. This process enables the removal of documents which, though similar, may cause negative user experiences.

The testing framework supports systematic evaluation of document performance before production deployment. Simulation mechanisms generate conversations based on problematic interaction patterns identified through user experience analysis. Controlled testing environments isolate document impact on conversation quality by maintaining consistent input conditions while varying knowledge base configurations.

Document 120 represents source documentation utilized by the conversational AI system 124 for response generation during user interactions. Multiple analysis pipelines process source documents through feedback evaluation mechanisms, topic extraction clustering models, and machine learning key-phrase identification systems. The analysis framework tracks document effectiveness through quantitative metrics when chatbot responses derive content from specific knowledge base sources.

Source documents establish baseline performance metrics for comparative analysis through document embedding techniques, vector search operations, and topic-based retrieval methods. Document analysis systems identify superior alternative content sources and documents that are most likely to cause more confusion to users when user experience metrics indicate negative feedback patterns or deteriorating interaction quality. The comparative framework evaluates semantic similarity between source materials while measuring relative response generation effectiveness.

The document processing architecture scales to handle documentation volumes exceeding 600,000 pages and 80 billion tokens in one or more embodiments. Source document identification within large-scale knowledge bases triggers systematic analysis procedures when content correlates with negative user experiences. Analysis outcomes guide knowledge base optimization through validated document alternatives and model fine-tuning operations. The improvement pipeline maintains document quality standards while enhancing response generation capabilities through continuous feedback-driven updates.

The document tracking system maintains explicit mappings between source materials and generated responses. Tracking mechanisms enable precise identification of problematic documentation through user experience analysis. Performance metrics guide systematic improvements by linking specific documents to conversation quality indicators. The analysis framework supports targeted enhancement of knowledge base content through validated alternative documentation sources.

Document 122 represents semantically similar documentation identified through automated analysis when source documents correlate with negative user experiences. The document identification system employs multiple search methodologies: document embedding algorithms generate high-dimensional vector representations; vector search operations locate proximate content in semantic space; and topic-based retrieval mechanisms identify thematically related materials. A feedback-driven analysis pipeline processes negative interaction signals to discover alternative documents with successful performance histories.

The document comparison framework executes similarity detection through key technical components. Topic clustering models group semantically related content based on extracted features. Key-phrase identification algorithms detect vocabulary overlaps between source and candidate documents. Readability scoring mechanisms evaluate documentation clarity through quantitative metrics. The analysis system combines these signals to identify promising document alternatives for response generation.

Document discovery activates when conversation segments exhibit deteriorating user experience metrics linked to specific knowledge base content. The identification pipeline locates semantically equivalent documentation through automated clustering and similarity scoring. Synthetic conversation generation tests document alternatives through controlled simulations. Performance evaluation quantifies user experience improvements achieved through alternative documentation sources.

The document analysis system maintains historical performance records across identified similar materials. Previous interaction outcomes guide document selection through success rate tracking. Systematic testing through conversation simulation validates document effectiveness before production deployment. The evaluation framework ensures consistent response quality improvement through data-driven documentation optimization.

The conversational AI system 124 executes natural language interactions through integrated processing and generation components. The system implements large language model architectures combined with retrieval augmented generation methods to produce contextually relevant responses. Document retrieval mechanisms augment language model capabilities through dynamic knowledge integration during response generation.

The response generation pipeline processes input queries through multiple analysis stages. Natural language understanding components extract semantic intent and contextual features. Knowledge retrieval systems identify relevant documentation through vector similarity and topic-based search operations. The language model synthesizes coherent responses by combining extracted knowledge with learned generation patterns.

System architecture scales to process high interaction volumes through distributed computing frameworks. Performance metrics demonstrate handling capacity of 300,000 chat sessions and 6 million utterances per six-month operational period. The processing pipeline maintains response quality through systematic knowledge integration and model-driven generation techniques.

Query processing incorporates multiple specialized components for comprehensive understanding. Language models analyze syntactic structure and semantic relationships within user input. Document retrieval mechanisms identify relevant knowledge through similarity matching algorithms. Response generation combines retrieved information with learned patterns to produce natural language outputs. The system maintains conversation coherence through context tracking and state management protocols.

The machine learning model(s) 126 implements model management and update procedures for the conversational AI system 124. The component executes model refinement based on documents demonstrating enhanced user experience metrics or deteriorated experience to serve as negative datapoints for the models. Multiple model architectures operate within the framework: document reranking models optimize content prioritization; embedding models compute semantic similarity representations; aggregator models process conversation features; and generative language models produce response sequences.

A training data creation framework drives systematic model improvement through multiple processing pipelines. The framework incorporates positive samples which improve user experience, baseline examples from the current retrieval model which generate bad experiences, and negative samples which further deteriorate user experience. Customer behavior analysis extracts interaction patterns from historical conversations, enabling both functional adaptation of the system and comprehensive evaluation metrics for future enhancements. This dual-purpose analysis supports extensibility by providing actionable insights for model refinement while establishing quantifiable benchmarks for measuring improvement over time. Synthetic conversation generation produces controlled training examples through document substitution. Pseudo-labeling mechanisms augment training datasets through automated annotation procedures.

Model refinement procedures incorporate demonstrated performance improvements from alternative documentation sources. The reranking architecture learns enhanced document prioritization patterns through simulated conversation outcomes. Embedding models adapt semantic representations based on validated document similarities. Aggregator models optimize feature extraction through analyzed conversation metrics. Language models integrate successful response patterns identified through synthetic testing.

The model update framework maintains system coherence through coordinated refinement of multiple model components. Training procedures preserve validated improvements while preventing degradation of existing capabilities. The framework enables continuous model enhancement through systematic processing of user interaction data and synthetic conversation generation.

The knowledge base(s) 128 comprises a scalable document storage and retrieval architecture supporting conversational AI operations. The system manages comprehensive documentation repositories through distributed storage mechanisms, enabling efficient access to response generation resources. Storage components maintain indexed records of document 120 associated with negative experience patterns and document 122 identified through similarity analysis.

The architecture scales to process documentation volumes exceeding 600,000 pages and 80 billion tokens of technical content. Document management subsystems implement advanced retrieval capabilities through key-phrase extraction and semantic similarity computations. Search functionality leverages vector representations and topic clustering to identify contextually relevant documentation during response generation.

Storage systems maintain hierarchical document organization through automated classification mechanisms. Retrieval operations execute through parallel processing pipelines optimized for high-throughput access patterns. Document indexing enables rapid similarity matching through pre-computed vector embeddings and topic associations. The framework supports dynamic updates while preserving referential integrity across document relationships.

Knowledge base components interface with response generation systems through standardized access protocols. Document retrieval mechanisms identify relevant content through multi-stage filtering operations. Storage optimization techniques balance access latency requirements with system resource constraints. The architecture maintains consistent performance characteristics under variable query loads through adaptive resource allocation.

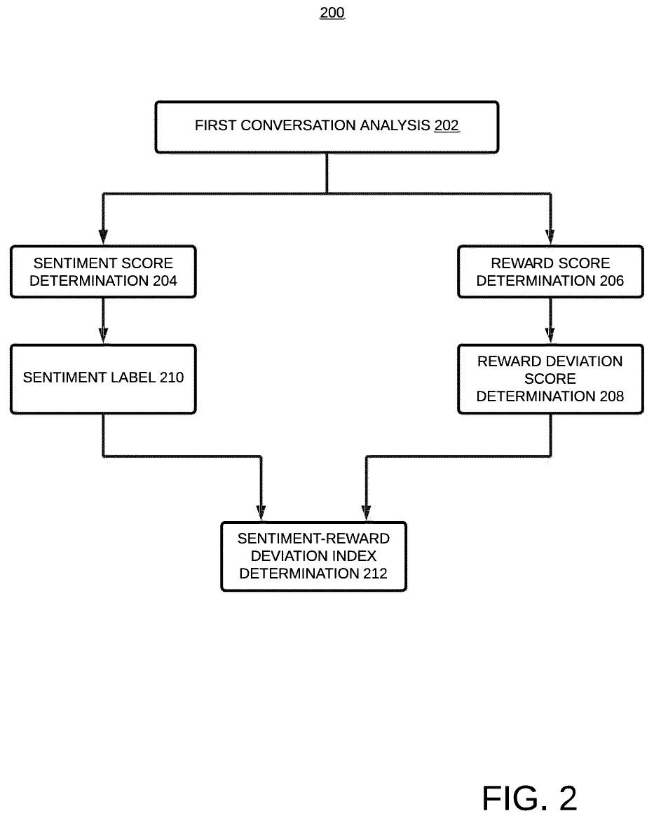

FIG. 2 illustrates a system and method 200 for analyzing conversations through sentiment scoring, reward scoring, reward deviation scoring, and sentiment labeling to determine sentiment-reward deviation indexes, according to one or more embodiments.

The system and method 200 extend the system and method 100 of FIG. 1 and analyze a conversation between a user and a conversational AI system by computing various metrics that help identify negative changes in user experience (Operation 202). The analysis begins by determining sentiment scores for the first conversation (Operation 204). These sentiment scores are numerical values that quantify the emotional tone or attitude expressed in each interaction of the conversation. The system and method 200 then calculate a set of reward scores for the conversation (Operation 206). Reward scores measure the effectiveness or success of interactions based on predefined criteria. Using the computed reward scores, the system and method 200 proceed to calculate reward deviation scores (Operation 208). These deviation scores measure how much reward scores differ from expected or baseline values or the previous reward score for the conversation. This helps identify unusual or problematic patterns in the conversation's progression. The final step combines the reward deviation scores with sentiment labels to generate sentiment-reward deviation indexes (Operation 212). The sentiment label for a given conversation query-answer pair can be determined using one of the two approaches described above: (1) by applying thresholds to a sentiment score determined for the given pair, or (2) applying thresholds to the minimum of: (a) the sentiment score determined for the given pair, and (b) a contextual sentiment score determined for the conversation so far up to the given pair.

The sentiment-reward deviation indexes are metrics that correlate emotional responses with conversation effectiveness. These indexes help pinpoint specific segments where user experience deteriorates, supporting the identification of conversation segments with negative changes in user experience. By quantifying both sentiment and reward deviations, the system and method 200 provide an approach to conversation analysis that can inform the AI system's improvement process.

A conversation analysis component performs analytical processing to evaluate user experience and conversation quality through multi-faceted analysis mechanisms (Operation 202). The component combines sentiment analysis, reward scoring, and deviation tracking approaches to generate comprehensive metrics.

The analysis component implements four primary analytical operations. Sentiment scoring assigns both discrete labels (Positive 1, Neutral 0, Negative −1) and continuous decimal values to user-chatbot message pairs. A weighted averaging method calculates overall conversation sentiment while preserving individual interaction scores. As mentioned, the sentiment label for a given conversation query-answer pair can be determined using one of the two approaches described above: (1) by applying thresholds to a sentiment score determined for the given pair, or (2) applying thresholds to the minimum of: (a) the sentiment score determined for the given pair, and (b) a contextual sentiment score determined for the conversation so far up to the given pair.

Reward scores ranging from −1 to 1 measure chatbot response effectiveness for message pairs and complete conversations. The component derives reward deviation scores by monitoring reward score changes throughout conversation duration. This monitoring enables detection of conversation quality shifts, particularly when performance varies from expected baselines.

A sentiment-reward deviation index emerges from combining reward deviation scores with sentiment labels. The combined metric serves as a user feedback proxy in conversations lacking explicit feedback mechanisms. Through user behavior tracking, the metric effectively identifies both negative and positive conversation patterns.

The quantitative metrics enable detection and measurement of user experience degradation within specific conversation segments. These measurements pinpoint precise locations of quality deterioration in ongoing conversations.

A sentiment score determination component evaluates sentiment throughout chat interactions within a conversation analysis system (Operation 202). The component calculates sentiment scores using a dual-scoring methodology for user-chatbot message pairs.

The sentiment scoring system produces two score types, discrete sentiment labels (Positive 1, Neutral 0, Negative −1) and continuous decimal scores. A message pair can receive both types, such as a discrete negative label (−1) and continuous score (−0.7), enabling precise measurement of negative sentiment levels when users respond to chatbot answers.

The sentiment scores serve as elements within an analysis framework that incorporate reward scores and deviation metrics. These quantitative measures indicate satisfaction and interaction quality levels. The system calculates weighted averages with emphasis on recent messages, providing accurate representations of emotional tone progression in conversations.

The sentiment scoring mechanism works in conjunction with an SADI to act as a feedback proxy when explicit user feedback does not exist. Message tone analysis detects increasing user frustration without direct feedback indicators. The scoring mechanism identifies subtle user experience changes that point to potential issues in chatbot responses or documentation content.

Determined sentiment scores enhance conversation analysis by delivering metrics for negative conversation segment identification and document-based response evaluation. The measurements enable improvements to conversational AI systems and associated knowledge bases.

A reward score determination component evaluates interaction quality and effectiveness in user-chatbot conversations (Operation 206). The component assigns reward scores from −1 to 1 for message pairs and complete conversations, measuring interaction success through quantitative metrics.

The reward score determination process operates within an analysis framework that incorporates sentiment scoring and deviation tracking mechanisms. Technical support conversations demonstrate operation of the system where reward scores reflect chatbot response effectiveness and conversation progression. The scores enable detection of user experience fluctuations across conversation segments.

A reward scoring mechanism works with sentiment analysis to evaluate conversation quality comprehensively. Score calculations span individual message pairs and complete conversations while generating deviation scores to monitor reward score changes during interactions. User expressions of frustration or repetitive question patterns yield reward scores that capture negative conversation progression.

The reward score determination process identifies significant user experience changes within conversation segments. Reward scores combine with sentiment labels to generate an SADI, providing feedback proxy capabilities for conversations lacking explicit user feedback. The feedback proxy functionality enables negative conversation context identification and analysis without direct user input.

A reward deviation score determination component analyzes conversation quality and user experience in conversational AI systems (Operation 208). The component calculates changes and deviations in reward scores during conversations to detect significant shifts in conversation quality and user satisfaction levels.

The scoring mechanism evaluates user-chatbot message pairs and complete conversations using a −1 to 1 scale. A user interaction sequence can progress from an initial reward score of 0.5 to subsequent scores of 0.2 and −0.3 , enabling the reward deviation score determination to compute changes that reveal negative conversation quality trends.

Sequential reward scores within conversations are measured through reward deviation scores. The deviation measurements detect sudden quality fluctuations that may indicate user experience deterioration or improvement points. A substantial negative deviation signals instances where chatbot responses contain incorrect or unhelpful information.

The deviation component works alongside sentiment analysis mechanisms to generate SADIs by combining deviation scores with sentiment labels. Combined metrics serve as feedback proxies for conversations lacking explicit user feedback indicators. Reward deviation scores support analysis of conversation segments including negative user experience changes, meeting specified requirements for segment identification.

Technical implementation maintains deviation tracking throughout conversations to determine precise locations and severity levels of quality changes. Tracking data enables system identification of problematic conversation segments and supports evaluation of alternative document-based responses through conversation simulation processes.

A sentiment label component 210 provides discrete categorical assessments of user sentiment during AI system conversations. Sentiment labels serve as core components for evaluating conversation quality and operate with reward scores and deviation metrics to detect negative changes in user experience.

The sentiment labeling system assigns three discrete values to user-chatbot message pairs: Positive (1), Neutral (0), and Negative (−1). A user message expressing frustration, like “This isn't helping at all,” receives a Negative (−1) sentiment label from the labeling system. These discrete labels combine supplementary metrics to generate SADIs, creating proxy measurements for user satisfaction when explicit feedback remains unavailable.

Sentiment labels emerge from system sentiment analysis capabilities that process multi-turn conversations. The sentiment analysis tracks sentiment changes throughout user interactions, identifying specific frustration points and improvement areas. Message pairs exhibiting sentiment label shifts from neutral to negative across multiple turns reveal problematic conversation segments requiring further analysis or system improvements.

The sentiment labeling mechanism advances the goal of detecting negative changes in conversation quality. The labeling system utilizes sentiment label patterns to pinpoint deteriorating user experience segments, enabling targeted improvements to conversational AI responses and underlying documentation content.

An SADI determination component processes conversation data using a multi-metric evaluation system for analyzing user experience (Operation 212). The component produces composite scores by combining sentiment analysis with reward-based feedback measurements. These composite scores enable continuous tracking of user satisfaction changes during active conversations.

The evaluation component begins by calculating sentiment scores for conversation message pairs. Sentiment calculations include both discrete labels (Positive 1, Neutral 0, Negative −1) and continuous decimal values. The processing system follows sentiment analysis with reward score computations ranging from −1 to 1, applying separate calculations to individual message pairs and complete conversations.

Reward deviation scores emerge from reward score changes throughout conversation sequences. Users displaying increasing frustration during troubleshooting sessions generate reward deviation scores that capture declining satisfaction trends. The analytical component merges deviation scores with sentiment labels to generate SADIs.

The SADI serves as a proxy measurement in conversations lacking explicit user feedback by integrating deviation patterns with sentiment analysis results. The proxy measurement capabilities detect negative conversation segments where user experience deteriorates, such as encounters with unclear documentation or ineffective chatbot responses.

The analytical component's calculations fulfill identification requirements for conversation segments including negative user experience changes. Concurrent tracking of sentiment and reward deviations reveals user satisfaction decline points during system interactions. The resulting measurements guide targeted enhancements to AI system responses and document selection mechanisms.

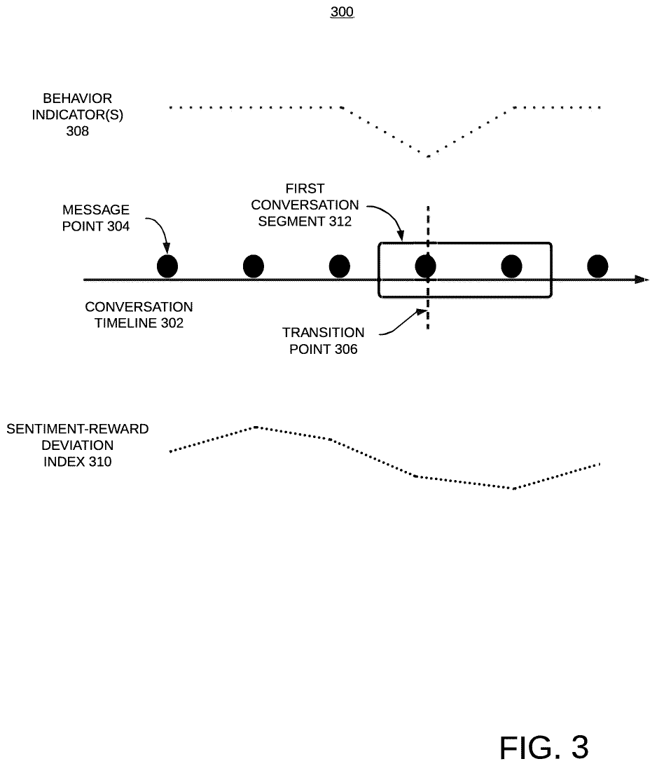

FIG. 3 illustrates a system and method 300 for detecting conversation transition points using behavioral indicators and SADIs to identify segments with negative user experience, according to one or more embodiments. The system and method 300 extend the system and method 100 of FIG. 1 for identifying conversation segments that indicate negative user experience in AI conversations.

The system and method 300 identify the first conversation segment 312 by detecting transition points 306 where user satisfaction notably decreases. The detection process employs at least one of two indicators, behavioral indicators 308 and/or an SADI 310. Behavioral indicators may include user actions or patterns that suggest dissatisfaction, such as repeated queries, shortened responses, or abrupt changes in interaction style. The SADI represents a quantitative measure that tracks changes in user sentiment and satisfaction levels throughout the conversation.

The system and method 300 monitor these indicators during the conversation analysis. When either indicator crosses a predetermined threshold, the crossing signals a transition point marking the onset of user dissatisfaction. This transition point helps define the boundaries of the first conversation segment where the negative change in user experience occurred. The identification process isolates the problematic portion of the conversation that needs improvement. These identified segments then guide the selection of alternative documents and the simulation of improved conversations, contributing to the enhancement of the AI system's conversational capabilities.

The conversation timeline representation 302 provides temporal analysis of user-AI system interactions, focusing on user satisfaction deterioration points. The representation combines behavioral indicators and sentiment-reward deviation indices to track sentiment scores (−1 to 1), reward scores, and behavioral signals like escalation requests or session abandonment. Changes in SADI values help determine Negative Conversation Context dynamically, particularly valuable when explicit feedback lacks.

Conversation message points 304 mark transitions in user experience and sentiment during AI system interactions. The system applies sentiment analysis with discrete labels (Positive 1, Neutral 0, Negative −1) and continuous decimal scores to message pairs. At these points, the system calculates deviation scores combined with sentiment labels for SADI computation, serving as user feedback proxy. Behavioral indicators like conversation abandonment or escalation requests supplement sentiment analysis for comprehensive experience tracking.

The transition point indicator 306 identifies precise moments of user experience deterioration through behavioral indicators and sentiment-reward metrics. The system monitors patterns like user rudeness, support escalation requests, ticket creation, and session abandonment as explicit transition markers. A weighted average scoring mechanism emphasizes recent messages for real-time detection of conversation tone changes, connecting deterioration points to specific query-answer pairs.

The behavioral indicator graph 308 visualizes user behavior patterns to detect negative experience changes. The graph plots various indicators, including conversation abandonment, human agent escalation requests, ticket creation, and abusive language instances. This visualization tool processes large-scale operations data, handling over 300,000 chat sessions and 6 million utterances in one or more embodiments within six-month periods through automated feedback analysis.

The sentiment-reward deviation index graph 310 visualizes combined sentiment and reward score changes throughout conversations. The graph plots sentiment-reward deviation indices across query-answer pairs, detecting satisfaction decline points. The visualization supports SADI implementation by showing downward trends indicating negative experiences even without explicit feedback.

The highlighted conversation segment 312 represents identified portions of negative user experience changes based on behavioral and sentiment-reward metrics. The system detects these segments through SADI analysis and transition point identification, monitoring sentiment shifts and behavioral indicators. Multiple detection mechanisms include sentiment label tracking, behavioral monitoring, deviation score calculation, and weighted average sentiment analysis.

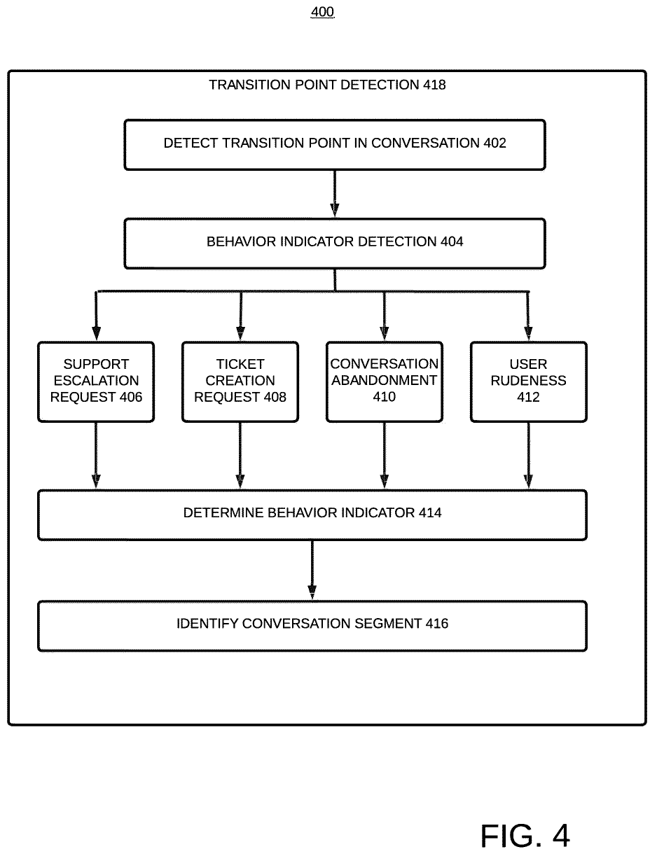

FIG. 4 illustrates a system and method 400 for detecting conversation transition points using behavioral indicators including support escalation, ticket creation, conversation abandonment, and user rudeness according to one or more embodiments. The system and method 400 extend the system and method 100 of FIG. 1 by implementing specific transition point detection based on user behavioral patterns.

The detection system establishes initial conversation segments through identification of precise transition markers that denote deteriorating user satisfaction. These transition markers manifest through observable behavioral indicators, that provide empirical evidence of user frustration or dissatisfaction during conversational exchanges. The system employs continuous monitoring protocols to track defined categories of user behavioral patterns.

The detection framework incorporates four primary behavioral indicators for measuring user dissatisfaction. The first indicator tracks user requests for human agent escalation, which signals AI system performance inadequacy. The second indicator monitors user-initiated support ticket generation, denoting conversation failure in issue resolution. The third indicator identifies conversation abandonment patterns, representing user frustration or diminished confidence in AI capabilities. The fourth indicator analyzes instances of user rudeness in query formation, correlating with elevated frustration levels in the interaction process.

The detection system leverages these behavioral indicators to establish definitive transition points within conversations. These transition points function as segment boundaries, enabling precise identification of conversation regions where user experience degradation began. The bounded segments undergo subsequent analysis for system improvement according to the parent claim's established methodology.

The detect transition point in conversation functionality 402 identifies moments of deteriorating user satisfaction through behavioral indicators. The detection mechanism monitors negative feedback signals, including support escalation requests, ticket creation initiation, conversation abandonment, and instances of rude communication. The system processes these indicators through data processing pipeline components to classify negative experiences and pinpoint deterioration points.

The behavior indicator detection 404 component analyzes user behaviors signaling dissatisfaction during AI interactions. The detection functionality monitors four patterns: support agent escalation requests, support ticket creation requests, premature conversation termination, and user rudeness in queries. The component integrates with data processing pipeline systems to capture and process these signals, complementing sentiment analysis and reward scores for comprehensive conversation quality evaluation.

The support escalation request 406 serves as a behavioral indicator marking conversation transition points. When users request human agent transfers, the system registers explicit signals of AI system inadequacy. The escalation requests enable precise identification of experience degradation points, facilitating analysis of AI responses and underlying documentation effectiveness.

The ticket creation request 408 functions as a behavioral signal indicating automated support insufficiency. The system processes ticket creation signals through data processing pipeline components alongside other behavioral indicators to identify degraded performance segments. These requests mark clear transition points where users determine human intervention necessity.

Conversation abandonment 410 represents premature session termination without resolution. The system processes abandonment signals within a user behavior tracking framework, analyzing over 300,000 chat sessions semi-annually in one or more embodiments. Abandonment detection triggers a data processing pipeline analysis to understand contextual factors and improve document retrieval mechanisms.

User rudeness detection 412 identifies hostile language and aggressive word choice through natural language processing capabilities. The system integrates rudeness detection with sentiment analysis and reward scoring mechanisms. Detection of user hostility triggers broader analysis processes, including problematic document identification and alternative conversation path simulation.

The determine behavior indicator component 414 examines support escalation requests, ticket creation, session abandonment, and user rudeness. The determination process operates within data processing pipeline components, providing objective measures for identifying improvement-needed segments. These indicators enable efficient processing of large-scale chat interactions through programmatic detection.

The identify conversation segment 416 component detects transition points through behavioral indicators and sentiment metrics. Segment identification incorporates support escalation requests, ticket creation, session abandonment, and user rudeness signals to enable targeted system improvements.

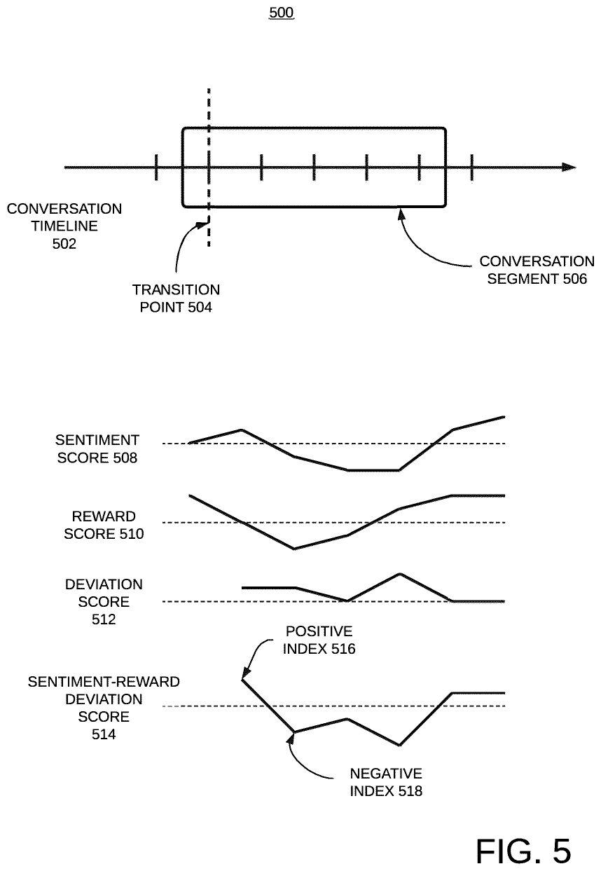

FIG. 5 illustrates a system and method 500 for detecting conversation transition points using sentiment scores, reward scores, and deviation indexes to identify segments indicating user dissatisfaction according to one or more embodiments.

This system and method 500 elaborate on the system and method 100 of FIG. 1 of identifying conversation segments that include negative user experiences by implementing a detailed analysis of sentiment and reward metrics. The system and method 500 focus on detecting transition points where user satisfaction deteriorates during the conversation with the AI system.

The analysis begins by calculating sentiment scores for the conversation segment under analysis. These sentiment scores quantify the emotional tone or attitude expressed by the user during different parts of the conversation. In parallel, the system and method 500 determine reward scores for the same conversation segment. Reward scores represent the effectiveness or value of the AI system's responses from a reinforcement learning perspective.

Using the reward scores as input, the system and method 500 calculate deviation scores for the conversation segment. These deviation scores measure how much the actual conversation outcomes differ from expected or optimal outcomes. The system and method 500 then combine the sentiment and reward information to compute sentiment-reward deviation indexes for the conversation segment. These indexes serve as composite metrics that capture both the user's emotional state and the conversation's effectiveness.

The system and method 500 identify transition points by examining the temporal progression of these sentiment-reward deviation indexes. Specifically, the system and method 500 look for patterns where the index transitions from positive to negative values. A positive sentiment-reward deviation index indicates a satisfactory user experience, while a negative value suggests user dissatisfaction. The system and method 500 confirm a transition point when detecting a negative sentiment-reward deviation index that follows a positive index in the sequence. This pattern signals the onset of user dissatisfaction and helps pinpoint where the conversation quality began to deteriorate.

The conversation timeline 502 chronologically tracks sentiment and reward scores to identify user experience transition points. The timeline visualizes sentiment-reward deviation indexes by plotting discrete sentiment labels (−1,0,1) and continuous decimal scores alongside reward scores (−1 to 1) for message pairs. A weighted average scoring mechanism emphasizes recent messages for accurate tone assessment.

The transition point indicator 504 identifies moments when user experiences shift from positive to negative through SADI analysis. The indicator monitors sentiment scores and reward scores continuously, detecting SADI transitions from positive to negative values. Multi-turn conversation analysis tracks sentiment changes to identify frustration points, enhanced by weighted message scoring.

The first conversation segment 506 encompasses detected negative shifts in user experience through sentiment and reward scoring analysis. The segment contains message pairs where SADIs transition between positive and negative values. This includes both conversations that deteriorate from positive to negative and those that improve from negative to positive states. Multiple scoring mechanisms, including −1 to 1 sentiment scores and reward scores, generate deviation metrics for comprehensive segment analysis.

The sentiment score graph 508 displays sentiment progression through discrete (−1, 0, 1) and continuous decimal scales for message pairs. The graph integrates SADIs to visualize sentiment transitions. The visualization component supports weighted average sentiment calculations with emphasis on recent messages.

The reward score graph 510 tracks message pair and conversation-level reward scores from −1 to 1. The graph plots reward score changes to identify effective transitions in conversations. Visual representation of reward metrics aids detection of conversation quality degradation points.

The deviation score graph 512 visualizes reward score changes throughout conversations. The graph plots calculated deviation scores derived from −1 to 1 reward scores assigned to message pairs. Visualization helps identify transition points where positive deviation scores shift negative.

The sentiment-reward deviation index plot 514 combines sentiment analysis and reward metrics to track user satisfaction changes. The plot displays discrete sentiment labels and continuous reward scores for message pairs, enabling identification of satisfaction deterioration points. The visualization supports SADI functionality for conversations lacking explicit feedback.

The positive index value 516 represents pre-transition sentiment-reward deviation measurements. The value establishes baseline satisfaction levels before deterioration occurs. The negative index value 518 indicates satisfaction decline through combined sentiment-reward analysis, supporting identification of problematic conversation segments requiring system improvements.

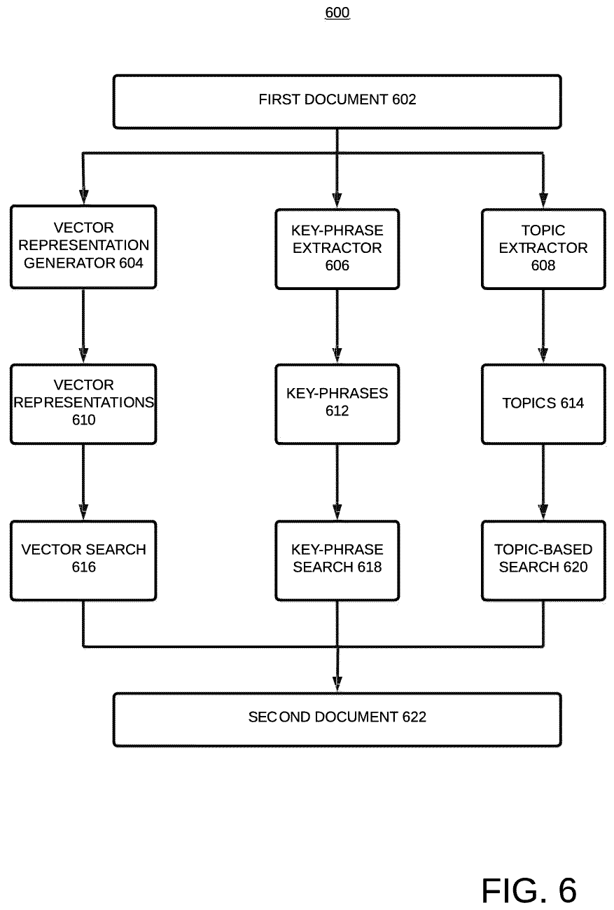

FIG. 6 illustrates a system and method 600 for identifying similar documents using parallel processing of vector representations, key-phrases, and topics extracted from a first document according to one or more embodiments. The system and method 600 extend the system and method 100 of FIG. 1 by implementing a process of identifying a second document that is similar to a first document used in a conversation with an AI system. The system and method 600 employs multiple computational approaches to ensure comprehensive document similarity matching.

The process begins by generating vector representations of the first document. These vectors are mathematical representations that capture the semantic meaning and content of the document in a high-dimensional space. The system and method 600 then extract key-phrases, which are significant words or phrases that characterize the content, from the first document. Additionally, the system and method 600 extract topics from the first document, representing broader thematic elements or subject matters discussed within the text.

Using these extracted features, the system and method 600 identify the second document through one or more search approaches. The first approach involves vector searches, where the system compares the vector representations of the first document against a corpus of documents to find similar semantic content. The second approach utilizes key-phrase searches, matching the extracted key-phrases against other documents to find those with similar terminology or concepts. The third approach employs topic-based searches, identifying documents that share similar thematic elements based on the extracted topics.

The identification process supports the objective of finding a similar document that might yield better conversation outcomes. Using vectors, key-phrases, and topics, the approach helps ensure that the identified second document maintains semantic and contextual similarity to the first document while potentially offering improved information for the conversational AI system to use.

The first document 602 serves as a baseline document that triggered negative user experiences in chat interactions. The document undergoes analysis through vector representation generation, key-phrase extraction, and topic extraction to identify similar but potentially more effective documentation. Analysis processes include generating vector embeddings, extracting technical key-phrases, and identifying primary topics.

The vector representation generator 604 creates numerical vector representations of documents for similarity comparison. The generator processes documents involved in negative user experiences to create vector embeddings, enabling semantic relationship to capture beyond keyword matching. Generated vectors facilitate efficient searching through large-scale documentation.

The key-phrase extractor 606 identifies significant phrases characterizing document content. The extractor employs specialized models to identify semantically significant phrases within technical documentation, generating search terms for similar document identification. The extraction process supports multifaceted document analysis across extensive documentation including billions of tokens.

The topic extractor 608 identifies main subject matters using in-house clustering models designed for technical documentation processing. The extractor enables topic-based searches for documents covering similar subject matter despite terminology variations. Topic extraction maintains document relevance across large-scale documentation bases.

Vector representations 610 comprise numerical representations capturing semantic meaning in high-dimensional space. The representations enable document similarity searches through embedding techniques, supporting feedback-driven document analysis. The representations work alongside topic clustering and key-phrase extraction for contextually appropriate document selection.

Key-phrases 612 represent extracted linguistic patterns used for finding related documentation. Specialized models extract key-phrases for semantic similarity searches. The key-phrases support document comparison processes by locating alternative documents during negative user interactions.

Topics 614 comprise extracted subject matter from document analysis operations. In-house clustering models extract topics as semantic markers for thematically similar document identification. Topics capture high-level conceptual similarities beyond direct text matching.

Vector search 616 performs similarity searches using document vector representations. The search functionality processes vectors to locate semantically similar content within knowledge bases including over 600,000 pages. Vector search operates alongside key-phrase and topic-based searches for comprehensive similarity detection.

Key-phrase search 618 identifies semantically similar documentation using extracted key-phrases. The search component supports technical documentation retrieval where concepts use varying terminology. Topic-based search 620 leverages extracted topics through in-house clustering models to find semantically related content.

The second document 622 represents similar documentation identified through vector representations, key-phrase analysis, and topic extraction. The document emerges through automated clustering and similarity analysis of large-scale documentation. The identification process supports continuous system optimization through alternative information source discovery.

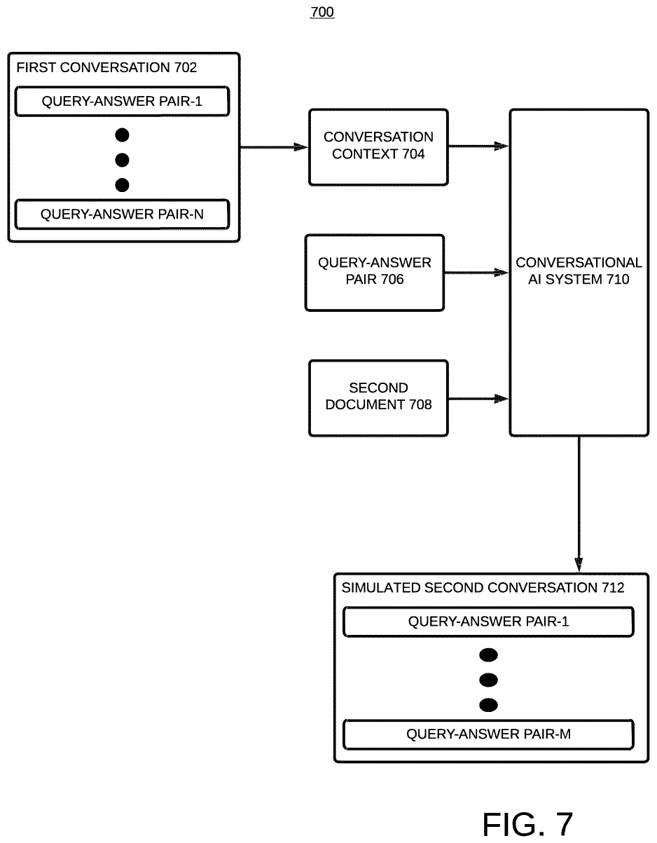

FIG. 7 illustrates a system and method 700 for simulating a second conversation using conversation context from a first conversation and a second document to generate an AI response according to one or more embodiments.

This system and method 700 build upon the system and method 100 of FIG. 1 of analyzing and improving conversational AI system responses. The simulation process requires two preparatory steps before generating the alternative response. First, the system identifies the relevant conversation context that preceded the problematic query-answer pair in the original conversation. The context captures the conversational state and any pertinent information exchanged before the query that led to the negative user experience. Second, the system assembles three components: the identified conversation context, the original query that triggered the problematic response, and the newly identified second document that differs from yet resembles the first document used in the original conversation. These three components serve as input to the conversational AI system. Using these inputs, the AI system generates a second answer to the same query, but now with the benefit of both the proper conversational context and the alternative document source. This structured approach ensures that the simulated response emerges under conditions that closely mirror the original conversation while incorporating the potentially better-suited second document as a knowledge source.

The first conversation 702 represents an actual user-AI system interaction that triggers analysis and improvement processes upon detecting negative experiences. The conversation undergoes analysis through sentiment scoring (−1 to 1), reward scores, and SADI metrics. Contextual information extraction enables simulation of alternative responses while maintaining conversational coherence.

Conversation context 704 encompasses historical user-AI system interactions preceding analyzed query-answer pairs. The context maintains conversational state and topic flow through previous exchanges, supporting SADI analysis for experience deterioration detection. Structured conversation history records preserve queries, responses, and metadata for simulation purposes.

Query-answer pair 706 forms interaction units including user queries and AI system responses. These pairs undergo sentiment analysis, reward scoring, and deviation tracking for experience evaluation. The pairs enable testing of alternative responses using different documentation while preserving contextual elements.

The second document 708 emerges through similarity comparison with problematic first documents. Document identification leverages embedding techniques, vector searches, and topic-based methods. The document undergoes simulation testing to validate improved outcomes before knowledge base incorporation, processing over 300,000 chat sessions within six-month periods.

The conversational AI system 710 performs multi-turn dialogue processing with context awareness capabilities. System components include sentiment tracking, reward scoring, and conversation confidence scoring mechanisms. Analysis components enable coherent response generation for both actual interactions and simulated conversations.

Simulated second conversation 712 generates synthetic exchanges using preserved contexts and alternative documentation. The simulation process tests document selection improvements through offline evaluation of knowledge base overlaps. Systematic testing of document combinations optimizes response quality before live system implementation, supporting continuous improvement through simulation-based validation.

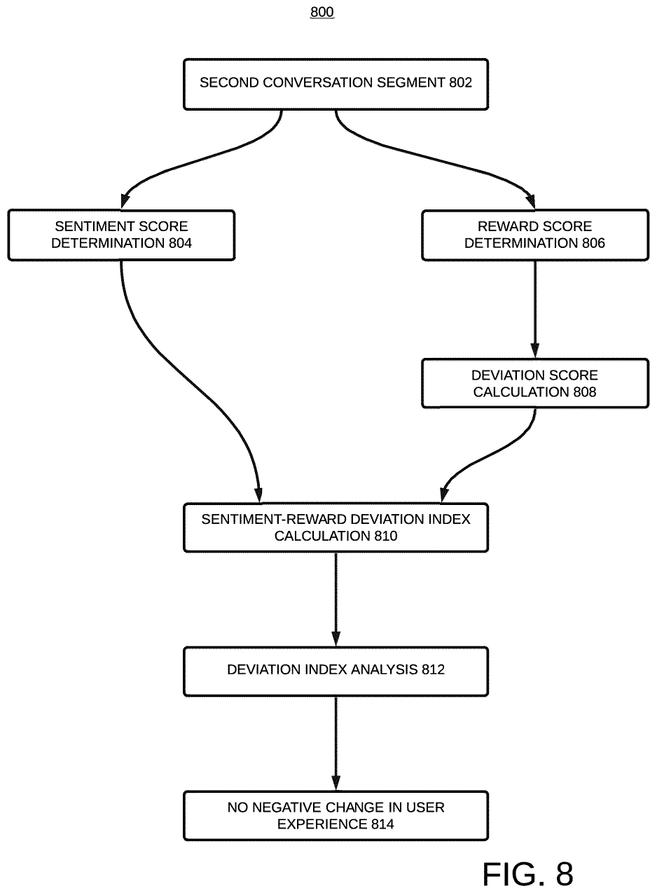

FIG. 8 illustrates a system and method 800 for determining conversation segment sentiment through analysis of sentiment scores, reward scores, and deviation indexes to evaluate user experience according to one or more embodiments.

This system and method 800 are for evaluating if a conversation segment exhibits a negative change in user experience by utilizing multiple scoring mechanisms and deviation analyses. The system and method 800 build upon the system and method 100 of FIG. 1 of simulating alternative conversations using different document sources.

The system and method 800 employ a multi-step scoring and analysis approach. The first step calculates sentiment scores for the second conversation segment, which quantify the emotional tone and attitude expressed in the conversation. These sentiment scores provide a baseline measurement of user satisfaction. Simultaneously, the method computes reward scores for the same conversation segment, which represent objective measures of conversation quality or task completion success.

The system and method 800 then process these reward scores to derive deviation scores for the conversation segment. These deviation scores measure how much the conversation's performance metrics differ from expected or baseline values. Using both sentiment and reward information, the system and method 800 calculate SADIs, which are composite metrics that capture the relationship between user sentiment and conversation performance.

The final determination regarding if the conversation segment lacks a negative change in user experience is based on a simple but effective criterion; SADIs in the calculated set are required to be positive. This positive value requirement indicates that the conversation maintains or improves upon expected performance levels while maintaining positive user sentiment throughout the segment. This evaluation approach ensures that both subjective user experience and objective performance metrics are considered in assessing conversation quality.

The second conversation segment 802 represents a simulated conversation portion corresponding to identified problematic segments from original interactions. The segment undergoes evaluation through sentiment scores, reward scores, deviation scores, and sentiment-reward deviation indexes. Analysis incorporates discrete (−1 to 1) sentiment scoring alongside continuous decimal scales, while reward scores evaluate chatbot response effectiveness.

Sentiment score determination 804 calculates user experience metrics through discrete labels (Positive 1, Neutral 0, Negative −1) and continuous decimal values. The scoring system evaluates technical support conversations by assigning sentiment values to user responses following chatbot explanations. Multi-metric assessment combines with reward scores and deviation scores for comprehensive quality evaluation.

Reward score determination 806 quantifies interaction quality through −1 to 1 scoring of query-answer pairs. The determination mechanism works with sentiment analysis for conversation evaluation, incorporating weighted average scoring that emphasizes recent messages. Generated reward scores support deviation score calculation and SADIs.

Deviation score calculation 808 processes reward score changes across consecutive message pairs, measuring quality shifts within conversation segments. The calculation analyzes rate and magnitude of reward score changes to identify significant quality transitions. Deviation scores integrate with SADI functionality as feedback proxies for simulated conversations.

SADI calculation 810 combines sentiment and reward metrics into comprehensive quality indicators. The calculation processes discrete sentiment labels, continuous scores, and reward values through weighted scoring mechanisms. SADI functionality serves as feedback proxy for simulated conversations lacking explicit user input.

Deviation index analysis 812 evaluates conversation quality through sequential query-answer pair processing. The analysis calculates sentiment scores and reward scores for message pairs, computing deviation scores from reward value changes. Analysis results support document evaluation and model improvement through quantitative measurements.

The no negative change in user experience 814 determination emerges from multi-faceted scoring analysis of simulated conversations. The determination combines sentiment scores, reward scores, and deviation calculations to verify maintained positive user experiences. When major negative experiences are identified, those documents are captured to use as negative training data for model training, ensuring that such documents are not identified as similar documents in future queries by the reranking system. SADI analysis confirms alternative document effectiveness through sustained positive metric values.

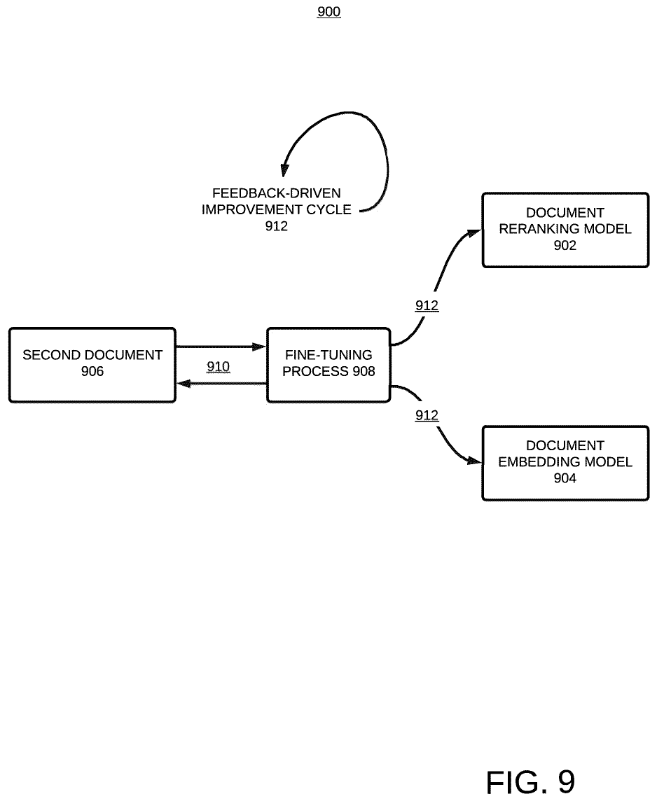

FIG. 9 illustrates a system and method 900 for fine-tuning document reranking and embedding models based on successful conversation outcomes using a second document according to one or more embodiments. Document Ranking training uses Query and Documents (Positive or Neutral or Negative or all or any combinations as per the training strategy). This system and method 900 include updating models in the conversational AI system following the determination that a simulated conversation segment shows improved user experience. The system and method 900 builds upon the system and method 100 of FIG. 1 of identifying and analyzing conversation segments, document usage, and simulation of alternative conversations.

When the system and method 900 determine that the second conversation segment demonstrates better user experience outcomes, the system and method 900 proceed to update specific models used by the conversational AI system. The updating process focuses particularly on two types of models, document reranking models and document embedding models. Document reranking models are fine-tuned using the second document as training data to improve their ability to prioritize and order relevant documents for future queries. Document embedding models that create vector representations of documents for efficient similarity comparisons are also fine-tuned using the second document to enhance document representation capabilities.

The fine-tuning process involves adjusting the model parameters based on the characteristics and content of the second document 906; this process has been shown to produce better conversation outcomes. This targeted model updating helps improve the conversational AI system's ability to select and utilize more relevant documents in future interactions. The system and method 900 focus on enhancing either the document ranking capabilities or the document representation capabilities of the system, or both, depending on the implementation.

The document reranking model 902 and document embedding model 904 form a specialized machine learning pipeline for optimizing document selection in chatbot responses. The reranking model handles document prioritization based on relevance metrics, while the embedding model generates vector representations for semantic similarity comparisons.

The system implements a feedback-driven improvement cycle 912 through multiple components. When negative user feedback occurs, the pipeline employs document embedding, vector search, and topic-based search methods to identify similar documents. The user behavior tracking module provides binary feedback (helpful/unhelpful) for chatbot responses, which serves as training data.

The document comparison process identifies second documents that demonstrate superior performance compared to problematic first documents through similarity matching. These second documents become positive examples for model fine-tuning. The system specifically searches for documents including semantically similar key-phrases to the first document.

The fine-tuning process block 908 updates both the reranking and embedding models using validated document alternatives that show improved performance in simulated conversations. The process incorporates multiple data sources, including direct customer feedback for A/B testing, user behavior tracking sentiment scores, and targeted conversations showing significant sentiment shifts as hard training samples.

Bidirectional arrows 910 represent continuous data exchange between conversation analysis and model fine-tuning components. The system processes chat sessions, identifying negative segments and simulating alternative conversations using similar documents discovered through vector search methods. Output arrows 912 indicate how successful simulations contribute to model refinements, specifically in document selection and ranking capabilities.

The system and method 900 demonstrate effectiveness in handling large-scale documentation while maintaining optimal document retrieval and ranking performance through continuous learning from user interactions.

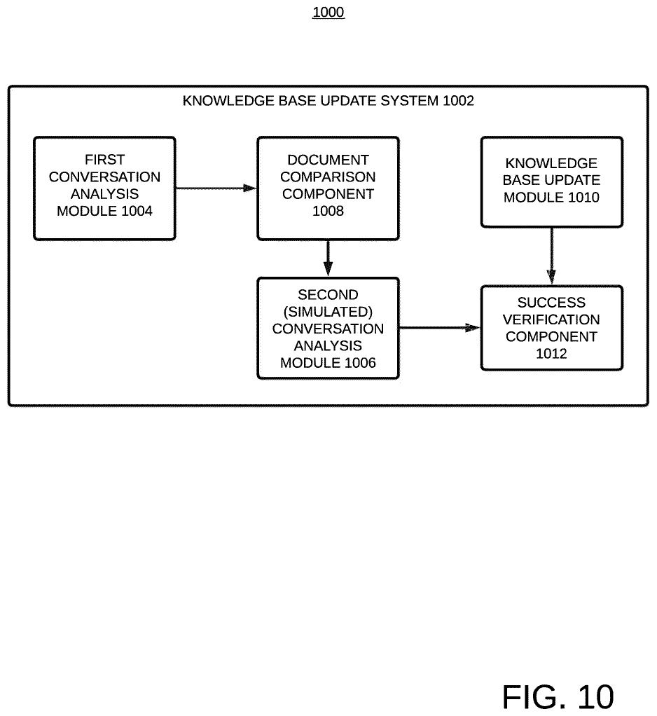

FIG. 10 illustrates a system and method 1000 for updating knowledge bases according to one or more embodiments. The system specifically identifies alternative documents that, when used in simulated conversations, produce better user experiences than those observed in original problematic interactions. When the simulation confirms that these alternative documents prevent the negative user experiences observed in real conversations, the system automatically incorporates these superior documents into the AI's knowledge base. This system and method 1000 are for a specific aspect of updating knowledge bases in a conversational AI system following the determination of improved user experience in simulated conversations as described above with respect to the system and method 100 of FIG. 1. After analyzing conversations and identifying segments with negative user experience, the system and method 1000 identifies alternative documents that could potentially provide better responses. When simulated conversation using these alternative documents does not result in negative user experience, the system and method 1000 proceed to update knowledge bases.

The knowledge base update process involves incorporating information from the second document that was identified as producing better conversation outcomes. This update modifies the existing knowledge bases that the conversational AI system uses to generate responses. The knowledge bases may include structured or unstructured data repositories, including information used by the AI system for answer generation. The update process ensures that the system's knowledge bases are enhanced with information that has been verified to produce more positive user interactions.

This system and method 1000 represent an iterative improvement process where the system learns from successful conversation patterns and incorporates supporting documentation into the knowledge base. The update helps the system avoid future negative user experiences by having access to information that has been demonstrated to produce better conversational outcomes. This approach allows the conversational AI system to continuously refine and improve the knowledge base through practical experience and validation.

The knowledge base update system 1002 maintains and improves conversational AI knowledge bases through analysis of conversation outcomes and document performance. The system processes chat sessions across pages and tokens, incorporating better-performing documents identified through conversation simulation while maintaining quality standards through readability scoring.

A first conversation analysis module 1004 performs multi-level evaluation of user-AI conversations to detect negative experience patterns. The module employs sentiment analysis with discrete labels (Positive 1, Neutral 0, Negative −1) and continuous decimal scores while calculating weighted conversation averages. The module leverages an SADI and CCS to identify deteriorating user satisfaction segments.

The second conversation analysis module 1006 evaluates simulated conversations generated with alternative documents. The module analyzes these simulations using sentiment analysis, reward scores, and deviation tracking to determine if alternative documentation produces improved outcomes. Upon detecting superior performance, the module flags candidate documents for knowledge base updates and initiates corresponding model updates, including refreshing embeddings to ensure the AI system properly incorporates the new information into its retrieval and response generation processes.

The document comparison component 1008 executes comparative analysis between documents using embedding, vector search, and topic-based search methods. The component extracts key-phrases and implements topic clustering to establish similarity between documents that caused negative experiences and potential alternatives with higher readability scores or more comprehensive explanations.

The knowledge base update module 1010 executes updates when analysis confirms superior performance of alternative documents. The module interfaces with document quality assessment features and maintains system coherence while reducing content overlap. The success verification component 1012 validates improvements through sentiment analysis, reward scores, and deviation tracking across statistically significant interaction samples, ensuring knowledge base updates result in measurable conversation quality improvements.

### 3.0 Example Embodiment

A detailed example is described below for purposes of clarity. Components and/or operations described below should be understood as one specific example that may not be applicable to certain embodiments. Accordingly, components and/or operations described below should not be construed as limiting the scope of any of the claims.

A cloud service provider implements techniques disclosed herein to improve customer support interactions. The techniques analyze customer conversations with an AI support agent handling cloud infrastructure inquiries. The analysis identifies conversation segments including negative user experiences such as when customers express frustration over receiving unclear explanations about virtual machine configuration options.

For a specific negative interaction, the techniques identify that the AI agent generated responses using an outdated technical documentation page about virtual machine instance types. The outdated documentation lacks details about newer GPU-accelerated instances, leading to customer confusion. The techniques then identify a similar but more current document describing the complete range of available instance types and specifications.

The techniques initiate a simulation using the identified current documentation. In the simulation, the AI agent responds to the same customer query about GPU instance options using information from the updated document. Analysis of the simulated conversation reveals improved customer satisfaction metrics as measured by reduced follow-up questions and positive sentiment indicators in customer responses.

Based on successful simulation results, the techniques update the knowledge base used by the AI support system. The update process incorporates the current VM instance documentation and deprecates references to outdated instance type descriptions. The knowledge base update includes metadata mapping customer inquiries about GPU acceleration to relevant sections of the current documentation.

The techniques continue monitoring subsequent customer conversations about VM configurations. Performance metrics show reduced customer confusion and faster resolution times for GPU instance inquiries after the knowledge base update. The automated optimization process enables the cloud provider's AI support system to maintain accuracy as cloud service offerings evolve.

This embodiment demonstrates the techniques'application in maintaining current and accurate AI support capabilities for rapidly changing technical products. The systematic approach to identifying and correcting knowledge gaps helps ensure consistent customer support quality across complex cloud service offerings.

### 4. Practical Applications, Advantages, and Improvements

One or more embodiments provide practical applications in continuously improving AI system performance based on real-world usage patterns. One or more embodiments automatically identify problematic conversation segments and trace these segments to specific source documents, enabling targeted improvements to knowledge resources.

An advantage stems from the ability of one or more embodiments to simulate alternative conversations using similar but unused documents. The simulation capability allows testing potential improvements before deploying changes to production systems. The simulation-based approach reduces risks associated with knowledge base and model updates by validating improvements in a controlled environment.

One or more embodiments improve conversational AI systems through automated optimization of underlying knowledge resources. When negative user experiences occur, one or more embodiments trace problems to specific documents and identify higher-quality alternatives. The automated identification and testing of alternative documents enable more rapid improvement cycles compared to manual analysis and updates.

One or more embodiments provide particular advantage in technical support applications, customer service environments, and sales support systems where documentation frequently changes. Support systems using one or more embodiments can automatically detect when outdated documentation causes user confusion and can identify current documentation that better addresses user queries. The automated detection and correction of documentation-related issues helps maintain support quality as products and services evolve.

Practical applications extend to enterprise knowledge management systems where multiple document versions exist. One or more embodiments help identify cases where AI systems reference superseded documents and automatically suggest current alternatives. The systematic approach to document evaluation and replacement helps maintain knowledge base consistency across large document collections.

One or more embodiments improve scalability of conversational AI maintenance by automating the analysis of user interactions and identification of problematic knowledge sources. Manual review of conversation logs and knowledge resources becomes impractical as usage volumes grow. The automated approach enables consistent quality improvement even with high conversation volumes.

Technical advantages include reduced latency in identifying and correcting knowledge gaps. One or more embodiments continuously monitor conversations and quickly identify segments indicating user confusion or frustration. The rapid detection of problems enables faster deployment of improvements compared to periodic manual reviews.

The simulation capability provides advantages in testing knowledge base updates of all kinds-including additions, deletions, modifications, and archiving of documentation. One or more embodiments evaluate potential improvements through automated conversation replay before modifying production systems. The simulation-based testing reduces risks of unintended effects when deploying knowledge base updates.

One or more embodiments improve maintenance efficiency through targeted updates to specific documents rather than broad knowledge base modifications. The precise identification of problematic documents enables focused improvements without disturbing unrelated content. The targeted update approach reduces system maintenance overhead while improving conversation quality.

### 5. Example Language Model Architecture

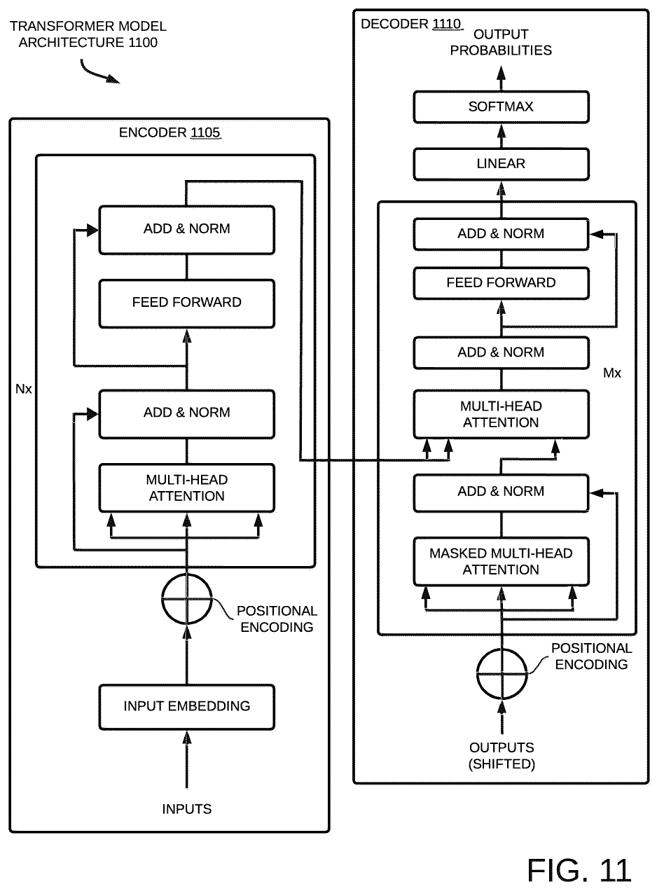

FIG. 11 illustrates an example transformer model architecture 1100 that may be used in the implementation of a language model according to one or embodiments of the present disclosure.

The transformer model architecture 1100 may be a neural network design for natural language processing. At its core, the architecture 1100 may encompass an encoder 1105 and a decoder 1110, both leveraging self-attention mechanisms. The architecture 1100 may begin with an input embedding layer that converts tokens into high-dimensional vector representations that may range, for example, from 128 to 1024 dimensions. These embeddings may be augmented with positional encodings to retain sequence order information.

The transformer model architecture 1100's input embedding layer serves as the initial processing stage for converting discrete tokens into continuous vector representations. These dense embeddings may occupy a high-dimensional space, with dimensionality configurations ranging from 128 to 1024, allowing for rich semantic representation of input tokens. The embedding process maps a token to a unique vector that captures the token's semantic properties in the continuous space. Positional encodings are subsequently added to these token embeddings through element-wise addition, introducing position-dependent signals that encode sequential information. These positional encodings can be implemented using sinusoidal functions or learned parameters, enabling the model to differentiate between tokens based on their positions in the sequence. The combined embeddings preserve both semantic content and sequential order, forming a foundation for the subsequent self-attention mechanisms. This embedding strategy addresses the inherent limitation of transformer architectures in processing sequential data, as the self-attention mechanism alone is position-agnostic.

The architecture 1100 may include a multi-head, self-attention mechanism. This may allow the architecture 1100 to simultaneously attend to different parts of the input sequence, capturing various types of relationships and dependencies. An attention head may compute query, key, and value vectors, enabling the model to focus on relevant parts of the input when processing a token. Following the attention layers, the architecture 1100 may incorporate feed-forward neural networks with multiple layers and non-linear activation functions.

The multi-head self-attention mechanism forms a component of the transformer architecture 1100, enabling parallel processing of input sequence elements. An attention head operates as an independent attention mechanism, computing three distinct matrices: queries (Q), keys (K), and values (V) through learned linear transformations of the input embeddings. The parallel nature of multiple attention heads allows the model to capture diverse relationship patterns within the same input sequence simultaneously, such as syntactic dependencies, semantic relationships, and long-range contextual connections. The attention computation follows the scaled dot-product attention formula, where the dot product between queries and keys determines alignment scores, followed by scaling and softmax normalization to produce attention weights. These weights are then applied to the value vectors, creating context-aware representations. The feed-forward neural networks following the attention layers include two linear transformations with a non-linear activation function (e.g., ReLU or GELU) between them, processing a position's output independently. This combination of self-attention and position-wise feed-forward networks enables the model to alternate between gathering contextual information across the sequence and applying complex transformations to individual positions, creating a powerful mechanism for sequence processing.

A masked, multi-head attention mechanism in the decoder 1110 of a transformer architecture 1100 may be designed to prevent the model from attending to future tokens during sequence generation. In this mechanism, multiple attention heads may operate in parallel, a computing query (Q), key (K), and value (V) matrices from the input embeddings. The attention scores may be calculated as the dot product of Q and K, scaled by the inverse square root of the dimension of the keys. A lower triangular mask may be applied to these attention scores before softmax normalization, effectively setting the upper triangular elements to negative infinity. This masking may ensure that a position can attend to previous positions in the sequence, maintaining the autoregressive property of the decoder. The masked attention scores may then be used to compute a weighted sum of the value vectors. The outputs from the heads may be concatenated and linearly transformed to produce the attention output. This process may allow the decoder to generate tokens sequentially while considering the previously generated tokens, thus preserving the causal nature of language modeling.

The masked multi-head attention mechanism in the transformer's decoder 1110 implements causal masking to enforce autoregressive generation during sequence processing. An attention head performs linear projections to create query (Q), key (K), and value (V) matrices from input embeddings through learned weight matrices WQ, WK, and WV respectively. The attention computation follows the formula Attention (Q, K, V)=softmax(QK^{T}/√dk)V, where dk represents the dimensionality of the key vectors. A lower triangular mask matrix gets added to the attention scores before softmax normalization. This mask sets all upper triangular elements to negative infinity (−∞), effectively zeroing out these positions after the softmax operation. The masking operation ensures strict causality by preventing any position from attending to future positions in the sequence during both training and inference. Following the masked attention computation, the outputs from multiple attention heads are concatenated along the feature dimension and projected through a final linear transformation WO to produce the layer's output. This output maintains the temporal causality required for autoregressive generation while still allowing a position to attend to all previous positions in the sequence. The parallelized implementation of multiple attention heads enables the model to capture various aspects of the sequence history simultaneously, while the masking mechanism maintains the sequential nature of language generation.

To maintain stable training and mitigate vanishing gradients, the architecture 1100 may employ layer normalization after a sub-layer (self-attention and feed-forward networks) and may introduce residual connections. These residual connections may allow unimpeded information flow through the network. The model may include multiple (Nx) encoder and decoder (Mx) layers stacked on top of each other, increasing its capacity to learn complex language patterns.

The transformer architecture incorporates stabilization techniques through layer normalization and residual connections. Layer normalization is applied after both the self-attention and feed-forward network sub-layers, normalizing the activations across the feature dimension for a token position. The normalization process computes the mean and variance of the features, then scales and shifts the normalized values using learned parameters gamma and beta, effectively standardizing the feature distributions throughout the network. Residual connections, implemented as skip connections, add the input of a sub-layer to the transformed output, creating direct paths for gradient flow during backpropagation. The combination of these components follows the formula LayerNorm(x+Sublayer(x)), where x represents the input and Sublayer represents either the self-attention or feed-forward network.

The stacking of multiple encoder and decoder layers increases the model's capacity logarithmically with respect to sequence length, enabling the capture of hierarchical patterns in language. An additional layer in the stack provides an opportunity for more abstract feature representation, with lower layers capturing local patterns and higher layers learning more complex, global dependencies. The interaction between layer normalization and residual connections creates a well-conditioned optimization landscape, facilitating stable training of deep transformer networks while mitigating the vanishing gradient problem that commonly affects deep neural architectures.

The output layer may involve a linear transformation followed by a softmax function, producing probability distributions over the vocabulary for text generation tasks. This architecture 1100's design may allow for efficient parallel processing of input sequences, making it particularly suitable for handling the extensive datasets used in training LLMs.

The output layer of the transformer architecture implements a vocabulary-sized classification mechanism through a linear transformation followed by softmax activation. The linear transformation projects the decoder's hidden states onto a vocabulary-sized space using a Weight Matrix W ∈ [symbol] (d_model ×|v|), Where D_model Represents the Model's Hidden

dimension and |V|represents the vocabulary size. The subsequent softmax function normalizes these logits into a proper probability distribution across the entire vocabulary, computing P(token_i) =exp(z_i)/Σ_j exp(z_j), where z_i represents the logit for the i-th vocabulary token. This architectural design enables efficient batch processing of input sequences through matrix multiplications, leveraging modern hardware accelerators like GPUs and TPUs. The parallel computation capability stems from the self-attention mechanism's ability to process all sequence positions simultaneously during the forward pass, requiring O(1) sequential operations compared to the O(n) operations needed in recurrent architectures. The model's parallelization efficiency scales particularly well with increasing sequence lengths, making the architecture advantageous for processing the extensive datasets used in large language model training, that often include billions of tokens across diverse domains and languages.

In one or more embodiments, architectural variations enhance or modify the standard transformer design for LLM implementations. The Sparse Transformer introduces structured sparsity patterns in the attention mechanism, reducing the quadratic memory complexity to linear complexity through fixed attention patterns. This modification enables processing of much longer sequences while maintaining model quality. Reformer architectures employ locality-sensitive hashing for attention computation, approximating full attention while significantly reducing memory requirements. The Performer architecture replaces the attention mechanism with kernel-based formulations using random feature decomposition, achieving linear complexity in both compute and memory.

Alternate positional encoding schemes offer various trade-offs. Rotary positional embeddings (RoPE) inject positional information through rotation matrices applied to token embeddings, providing better relative position modeling. Alibi position embeddings add learned bias terms to attention scores, enabling better extrapolation to sequences longer than those seen during training. Some architectures eliminate explicit positional encodings entirely, instead relying on position-aware linear attention mechanisms.

Architecture modifications also target specific computational bottlenecks. Flash Attention optimizes attention computation through careful management of GPU memory access patterns. Mixture of Experts (MoE) architectures incorporate specialized sub-networks activated based on input patterns, increasing model capacity without proportional computation increases. The GLU (Gated Linear Unit) variants replace standard feed-forward networks with gated mechanisms, providing more flexible function approximation. Multi-query attention reduces memory bandwidth requirements by sharing key and value projections across attention heads while maintaining separate query projections.

Some architectures focus on improved training dynamics. DeepNorm modifies the layer normalization scheme to enable stable training of deeper networks. Gradient checkpointing strategies reduce memory requirements during training by recomputing certain activations during backpropagation. State space models offer an alternative to attention mechanisms entirely, using linear state space equations to model sequence relationships with improved computational efficiency.

Alternative architectures for LLM implementation encompass distinct paradigms beyond transformers. Recurrent Neural Networks (RNNs), particularly variants like Long Short-Term Memory (LSTM) networks and Gated Recurrent Units (GRUs), process sequences sequentially through hidden state updates. These architectures maintain explicit temporal dependencies through gating mechanisms, controlling information flow between timesteps. LSTM networks employ three gates—input, forget, and output—along with a memory cell to regulate information persistence. GRUs simplify this structure with reset and update gates while maintaining comparable performance.

Convolutional Neural Networks (CNNs) offer another approach through hierarchical feature extraction. Temporal Convolutional Networks (TCNs) apply dilated convolutions to capture long-range dependencies while maintaining autoregressive properties. The hierarchical structure of TCNs enables parallel processing within a layer while preserving causal relationships. Quasi-Recurrent Neural Networks (QRNNs) combine convolutional and recurrent approaches, using convolution for parallel feature extraction followed by a lightweight recurrent pooling mechanism.

Memory-augmented architectures present another paradigm. Neural Turing Machines (NTMs) and Differentiable Neural Computers (DNCs) supplement neural processing with external memory arrays, accessed through attention-like mechanisms. These architectures separate computation from memory storage, enabling more explicit modeling of long-term dependencies. Memory Networks similarly incorporate dedicated memory components but with more structured addressing mechanisms.

Continuous-time models offer an alternative perspective on sequence processing. Neural Ordinary Differential Equations (Neural ODEs) model sequence evolution as a continuous-time dynamical system, solving differential equations to process inputs. This approach enables variable timestep processing and potentially more natural handling of temporal relationships. Similarly, Neural Controlled Differential Equations (Neural CDEs) extend this framework to handle irregular time series data while maintaining end-to-end differentiability.

Graph Neural Networks (GNNs) provide yet another alternative by modeling sequences as structured graphs. This approach enables explicit modeling of hierarchical relationships and long-range dependencies through message passing between nodes. Graph-based architectures can capture complex dependencies that may be difficult to model with purely sequential approaches, though these architectures may require careful design of graph structure and update rules. 6. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as a physical network). A node in an overlay network corresponds to a respective node in the underlying network. Hence, a node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In one or more embodiments, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In one or more embodiments, a computer network provides connectivity between clients and network resources. Network resources include hardware and/or software configured to execute server processes. Examples of network resources include a processor, data storage, a virtual machine, a container, and/or a software application. Network resources are shared amongst multiple clients. Clients request computing services from a computer network independently of each other. Network resources are dynamically assigned to the requests and/or clients on an on-demand basis.

Network resources assigned to a request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In one or more embodiments, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, that are executing on the network resources. In PaaS, the service provider provides end users the capability to deploy custom applications onto the network resources. Custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In one or more embodiments, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In one or more embodiments, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In one or more embodiments, a tenant is associated with a tenant ID. An network resource of the multi-tenant computer network is tagged with a tenant ID. A tenant is permitted access to a particular network resource if the tenant and the particular network resources are associated with a same tenant ID.

In one or more embodiments, a tenant is associated with a tenant ID. An application, implemented by the computer network, is tagged with a tenant ID. Additionally, or alternatively, a data structure and/or dataset, stored by the computer network, is tagged with a tenant ID. A tenant is permitted access to a particular application, data structure, and/or dataset if the tenant and the particular application, data structure, and/or dataset are associated with a same tenant ID.

As an example, a database implemented by a multi-tenant computer network may be tagged with a tenant ID. Only a tenant associated with the corresponding tenant ID may access data of a particular database. As another example, a entry in a database implemented by a multi-tenant computer network may be tagged with a tenant ID. Only a tenant associated with the corresponding tenant ID may access data of a particular entry. However, the database may be shared by multiple tenants.

In one or more embodiments, a subscription list indicates that tenants have authorization to access that applications. For an application, a list of tenant IDs of tenants authorized to access the application is stored. A tenant is permitted access to a particular application if the tenant ID of the tenant is included in the subscription list corresponding to the particular application.

In one or more embodiments, network resources (such as digital devices, virtual machines, application instances, and threads) corresponding to different tenants are isolated to tenant-specific overlay networks maintained by the multi-tenant computer network. As an example, packets from any source device in a tenant overlay network may be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network. 7. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

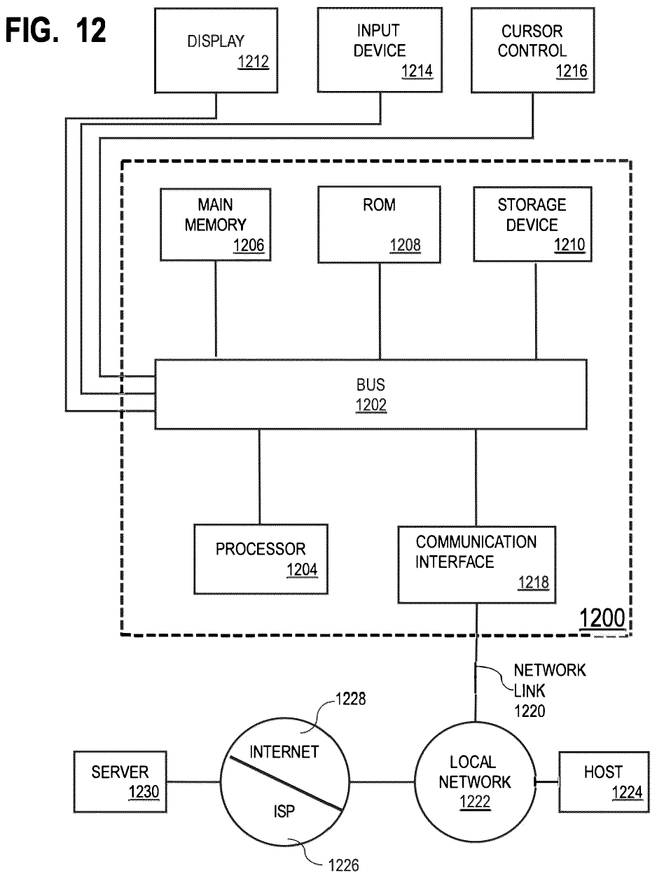

FIG. 12 is a block diagram that illustrates an example computer system 1200 upon which one or more embodiments are implemented. Computer system 1200 includes a bus 1202 or other communication mechanism for communicating information, and a hardware processor 1204 coupled with bus 1202 for processing information. Hardware processor 1204 may be, for example, a general-purpose microprocessor.

Computer system 1200 also includes a main memory 1206, such as a random-access memory (RAM) or other dynamic storage device, coupled to bus 1202 for storing information and instructions to be executed by processor 1204. Main memory 1206 also may be used for storing temporary variables or other intermediate information during execution of instructions to be executed by processor 1204. Such instructions, when stored in non-transitory storage media accessible to processor 1204, render computer system 1200 into a special-purpose machine that is customized to perform the operations specified in the instructions.

Computer system 1200 further includes a read only memory (ROM) 1208 or other static storage device coupled to bus 1202 for storing static information and instructions for processor 1204. A storage device 1210, such as a magnetic disk, optical disk, or a Solid-State Drive (SSD) is provided and coupled to bus 1202 for storing information and instructions.

Computer system 1200 may be coupled via bus 1202 to a display 1212, such as a cathode ray tube (CRT), for displaying information to a computer user. An input device 1214, including alphanumeric and other keys, is coupled to bus 1202 for communicating information and command selections to processor 1204. Another type of user input device is cursor control 1216, such as a mouse, a trackball, or cursor direction keys for communicating direction information and command selections to processor 1204 and for controlling cursor movement on display 1212. This input device typically has two degrees of freedom in two axes, a first axis (e.g., x) and a second axis (e.g., y), that allows the device to specify positions in a plane.

Computer system 1200 may implement the techniques described herein using customized hard-wired logic, one or more ASICs or FPGAs, firmware and/or program logic that in combination with the computer system causes or programs computer system 1200 to be a special-purpose machine. According to one embodiment, the techniques herein are performed by computer system 1200 based on processor 1204 executing one or more sequences of one or more instructions contained in main memory 1206. Such instructions may be read into main memory 1206 from another storage medium, such as storage device 1210. Execution of the sequences of instructions contained in main memory 1206 causes processor 1204 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 1210. Volatile media includes dynamic memory, such as main memory 1206. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 1202. Transmission media can also take the form of acoustic or light waves, such as those generated during radio-wave and infra-red data communications.

Various forms of media may be involved in carrying one or more sequences of one or more instructions to processor 1204 for execution. For example, the instructions may initially be carried on a magnetic disk or solid-state drive of a remote computer. The remote computer can load the instructions into its dynamic memory and send the instructions over a telephone line using a modem. A modem local to computer system 1200 can receive the data on the telephone line and use an infra-red transmitter to convert the data to an infra-red signal. An infra-red detector can receive the data carried in the infra-red signal and appropriate circuitry can place the data on bus 1202. Bus 1202 carries the data to main memory 1206, from that processor 1204 retrieves and executes the instructions. The instructions received by main memory 1206 may optionally be stored on storage device 1210 either before or after execution by processor 1204.

Computer system 1200 also includes a communication interface 1218 coupled to bus 1202. Communication interface 1218 provides a two-way data communication coupling to a network link 1220 that is connected to a local network 1222. For example, communication interface 1218 may be an integrated services digital network (ISDN) card, cable modem, satellite modem, or a modem to provide a data communication connection to a corresponding type of telephone line. As another example, communication interface 1218 may be a local area network (LAN) card to provide a data communication connection to a compatible LAN. Wireless links may also be implemented. In any such implementation, communication interface 1218 sends and receives electrical, electromagnetic or optical signals that carry digital data streams representing various types of information.

Network link 1220 typically provides data communication through one or more networks to other data devices. For example, network link 1220 may provide a connection through local network 1222 to a host computer 1224 or to data equipment operated by an Internet Service Provider (ISP) 1226. ISP 1226 in turn provides data communication services through the worldwide packet data communication network now commonly referred to as the “Internet” 1228. Local network 1222 and Internet 1228 both use electrical, electromagnetic or optical signals that carry digital data streams. The signals through the various networks and the signals on network link 1220 and through communication interface 1218, that carry the digital data to and from computer system 1200, are example forms of transmission media.

Computer system 1200 can send messages and receive data, including program code, through the network(s), network link 1220 and communication interface 1218. In the Internet example, a server 1230 might transmit a requested code for an application program through Internet 1228, ISP 1226, local network 1222 and communication interface 1218.

The received code may be executed by processor 1204 as it is received, and/or stored in storage device 1210, or other non-volatile storage for later execution. 8. Miscellaneous; Extensions

Unless otherwise defined, all terms (including technical and scientific terms) are to be given their ordinary and customary meaning to a person of ordinary skill in the art and are not to be limited to a special or customized meaning unless expressly so defined herein.

This application may include references to certain trademarks. Although the use of trademarks is permissible in patent applications, the proprietary nature of the marks should be respected, and every effort made to prevent their use in any manner that might adversely affect their validity as trademarks.

Embodiments are directed to a system with one or more devices that include a hardware processor and that are configured to perform any of the operations described herein and/or recited in any of the claims below.

In one or more embodiments, one or more non-transitory computer readable storage media comprises instructions that, when executed by one or more hardware processors, cause performance of any of the operations described herein and/or recited in any of the claims.

In one or more embodiments, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in that such claims issue, including any subsequent correction.

1. One or more non-transitory computer-readable media storing a set of instructions that, when executed by a set of one or more processors, cause a set of one or more computer systems to perform a set of operations comprising:
analyzing a first conversation between a user and a conversational artificial intelligence (AI) system, wherein analyzing the first conversation comprises: determining a set of sentiment scores for the first conversation, determining a set of reward scores for the first conversation, determining a set of reward deviation scores for the first conversation based on at least the set of reward scores for the first conversation, and determining a set of sentiment-reward deviation indexes based on at least the determining the set of reward deviation scores and a set of sentiment labels;
identifying a first conversation segment of the first conversation encompassing a negative change in user experience, wherein the first conversation segment comprises a set of query-answer pairs of the first conversation;
identifying a first document that was used by the conversational AI system to generate a first answer of a query-answer pair of the set of query-answer pairs, the query-answer pair comprising a query and the first answer;
identifying a second document that is similar to the first document, wherein the second document was not used by the conversational AI system to generate the first answer of the query-answer pair;
simulating a second conversation based at least on the second document, wherein the simulating the second conversation comprises causing the conversational AI system to generate a second answer to the query of the query-answer pair;
determining that a second conversation segment, of the second conversation, corresponding to the first conversation segment, of the first conversation, does not encompass a negative change in user experience; and
responsive at least to determining that the second conversation segment does not encompass a negative change in user experience, updating one or more models and/or one or more knowledge bases used by the conversational AI system based on the second document.

2. The one or more non-transitory computer-readable media of claim 1, wherein the set of sentiment labels comprises positive one, zero, and negative one.

3. The one or more non-transitory computer-readable media of claim 1, wherein the identifying the first conversation segment encompassing a negative change in user experience is based on at least detecting a transition point in the first conversation based on at least a behavioral indicator that indicates an onset of user dissatisfaction; and wherein the detecting the transition point is based on at least the behavioral indicator; and wherein the set of operations further comprise:
determining the behavior indicator based on at least detecting at least one of:
a support escalation request associated with the first conversation,
a support ticket creation request associated with the first conversation,
a user abandonment of the first conversation, or user rudeness in a query of the first conversation.

4. The one or more non-transitory computer-readable media of claim 1, wherein the identifying the first conversation segment encompassing a negative change in user experience is based on at least detecting a transition point in the first conversation based on at least a sentiment-reward deviation index that indicates an onset of user dissatisfaction; and wherein the set of operations further comprise:
determining a set of sentiment scores for the first conversation segment;
determining a set of reward scores for the first conversation segment;
determining a set of deviation scores for the first conversation segment;
determining a set of sentiment-reward deviation indexes for the first conversation segment, wherein the sentiment-reward deviation index is in the set of sentiment-reward deviation indexes;
determining that the sentiment-reward deviation index is negative; and
determining that a prior sentiment-reward deviation index in the set of sentiment-reward deviation indexes is positive.

5. The one or more non-transitory computer-readable media of claim 1, wherein the identifying the second document is based on at least one of:
performing one or more vector searches using a set of one or more vector representations of the first document, performing one or more key-phrase searches using a set of one or more key-phrases extracted from the first document, or performing one or more topic-based searches using a set of one or more topics extracted from the first document.

6. The one or more non-transitory computer-readable media of claim 1, wherein the simulating the second conversation is based on at least:
identifying, from the first conversation, a conversation context preceding the query of the query-answer pair; and
providing the conversation context, the query, and the second document to the conversational artificial intelligence (AI) system for generating the second answer.

7. The one or more non-transitory computer-readable media of claim 1, wherein the determining that the second conversation segment does not correspond to a negative change in user experience is based on at least:
determining a set of sentiment scores for the second conversation segment;
determining a set of reward scores for the second conversation segment;
based on the determining the set of reward scores, determining a set of deviation scores for the second conversation segment;
based on the determining the set of deviation scores, determining a set of sentiment-reward deviation indexes for the second conversation segment; and
determining that sentiment-reward deviation indexes in the set of sentiment-reward deviation indexes are positive.

8. A method comprising:
analyzing a first conversation between a user and a conversational artificial intelligence (AI) system;
identifying a first conversation segment of the first conversation encompassing a negative change in user experience, wherein the first conversation segment comprises a set of query-answer pairs of the first conversation;
identifying a first document that was used by the conversational AI system to generate a first answer of a query-answer pair of the set of query-answer pairs, the query-answer pair comprising a query and the first answer;
identifying a second document that is similar to the first document, wherein the second document was not used by the conversational AI system to generate the first answer of the query-answer pair;
simulating a second conversation based on at least the second document, wherein the simulating the second conversation comprises causing the conversational AI system to generate a second answer to the query of the query-answer pair;
determining that a second conversation segment, of the second conversation, corresponding to the first conversation segment, of the first conversation, does not encompass a negative change in user experience; and
updating one or more models and/or one or more knowledge bases used by the conversational AI system based on at least the second document.

9. The method of claim 8, wherein the analyzing the first conversation comprises:
determining a set of sentiment scores for the first conversation;
determining a set of reward scores for the first conversation;
based on at least the determining the set of reward scores, determining a set of reward deviation scores for the first conversation; and
based on at least the determining the set of reward deviation scores and a set of sentiment labels, determining a set of sentiment-reward deviation indexes.

10. The method of claim 9, wherein the set of sentiment labels comprises positive one, zero, and negative one.

11. The method of claim 8, wherein identifying the first conversation segment encompassing a negative change in user experience is based on at least:
detecting a transition point in the first conversation based on at least a behavioral indicator and/or a sentiment-reward deviation index that indicates an onset of user dissatisfaction.

12. The method of claim 11, wherein the detecting the transition point is based on at least the behavioral indicator; and wherein the method further comprises:
determining the behavior indicator based on at least detecting at least one of:
a support escalation request associated with the first conversation, a support ticket creation request associated with the first conversation, a user abandonment of the first conversation, or user rudeness in a query of the first conversation.

13. The method of claim 11, wherein the detecting the transition point is based on at least the sentiment-reward deviation index; and wherein the method further comprises:
determining a set of sentiment scores for the first conversation segment;
determining a set of reward scores for the first conversation segment;
determining a set of deviation scores for the first conversation segment;
determining a set of sentiment-reward deviation indexes for the first conversation segment, wherein the sentiment-reward deviation index is in the set of sentiment-reward deviation indexes;
determining that the sentiment-reward deviation index is negative; and
determining that a prior sentiment-reward deviation index in the set of sentiment-reward deviation indexes is positive.

14. The method of claim 8, wherein the identifying the second document is based on at least one of:
performing one or more vector searches using a set of one or more vector representations of the first document, performing one or more key-phrase searches using a set of one or more key-phrases extracted from the first document, or performing one or more topic-based searches using a set of one or more topics extracted from the first document.

15. The method of claim 8, wherein the simulating the second conversation is based on at least:
identifying, from the first conversation, a conversation context preceding the query of the query-answer pair; and
providing the conversation context, the query, and the second document to the conversational artificial intelligence (AI) system for generating the second answer.

16. The method of claim 8, wherein determining that the second conversation segment does not correspond to a negative change in user experience is based on at least:
determining a set of sentiment scores for the second conversation segment;
determining a set of reward scores for the second conversation segment;
determining a set of deviation scores for the second conversation segment;
determining a set of sentiment-reward deviation indexes for the second conversation segment;
and determining that all sentiment-reward deviation indexes in the set of sentiment-reward deviation indexes are positive.

17. The method of claim 8, further comprising:
updating one or more models used by the conversational AI system based on at least the second document; and
wherein the updating the one or more models comprises at least one of:
fine-tuning a document reranking model based on at least the second document; or
fine-tuning a document embedding model based on at least the second document.

18. The method of claim 8, further comprising:
updating one or more knowledge bases used by the conversational AI system based on at least the second document.

19. A system comprising:
a set of one or more computer systems having one or more hardware processors; and
a set of instructions that, when executed, cause the set of one or more computer systems to perform a set of operations comprising:
analyzing a first conversation between a user and a conversational artificial intelligence (AI) system, wherein analyzing the first conversation comprises: determining a set of sentiment scores for the first conversation, determining a set of reward scores for the first conversation, determining a set of reward deviation scores for the first conversation based on at least the set of reward scores for the first conversation, and determining a set of sentiment-reward deviation indexes based on at least the determining the set of reward deviation scores and a set of sentiment labels;
identifying a first conversation segment of the first conversation encompassing a negative change in user experience, wherein the first conversation segment comprises a set of query-answer pairs of the first conversation;
identifying a first document that was used by the conversational AI system to generate a first answer of a query-answer pair of the set of query-answer pairs, the query-answer pair comprising a query and the first answer;
identifying a second document that is similar to the first document, wherein the second document was not used by the conversational AI system to generate the first answer of the query-answer pair;
simulating a second conversation based on at least the second document, wherein the simulating the second conversation comprises causing the conversational AI system to generate a second answer to the query of the query-answer pair;
determining that a second conversation segment, of the second conversation, corresponding to the first conversation segment, of the first conversation, does not encompass a negative change in user experience; and
updating one or more models and/or one or more knowledge bases used by the conversational AI system based on at least the second document.

20. The system of claim 19, the set of operations further comprising:
updating one or more models used by the conversational AI system based on at least the second document; and
wherein the updating the one or more models comprises at least one of:
fine-tuning a document reranking model based on at least the second document; or
fine-tuning a document embedding model based on at least the second document.
